(19) United States
(12) Patent Application Publication
(10) Pub. No.: US 2020/0090121 A1
(43) Pub. Date: Mar. 19, 2020

(54) METHOD AND SYSTEM FOR FACILITATING DELIVERY OF PARCELS TO USERS

(71) Applicants: Grey Orange Pte. Ltd., Singapore (SG); Project Verte Inc., Dover, DE (US)

(72) Inventor: Akash Gupta, Delhi (IN)

(21) Appl. No.: 16/548,974

(22) Filed: Aug. 23, 2019

Related U.S. Application Data
(60) Provisional application No. 62/722,398, filed on Aug. 24, 2018.

(51) Int. Cl. G06Q 10/08; G06Q 10/04; G05D 1/02; G05D 1/00; G06Q 50/28; H04W 4/029

(52) U.S. Cl. CPC G06Q 10/08355; G06Q 10/0833; G06Q 10/087; H04W 4/029; G05D 1/0225; G05D 1/0022; G06Q 50/28; G06Q 10/047

(57) ABSTRACT

A system for facilitating delivery of a first parcel to a first user is provided. The system includes automated guided vehicles (AGVs) stationed at a buffer storage. The buffer storage stores the first parcel for delivering the first parcel to the first user at a first destination location. The system further includes an order management server that is communicatively coupled to the one or more AGVs. The order management server receives location information from a user-device of the first user. Based on the received location information, the order management server tracks a location of the first user. The order management server further communicates a first instruction to a first AGV to load the first parcel and deliver the first parcel to the first user at a destination location when the location of the first user matches the first destination location.

### CROSS REFERENCE TO RELATED APPLICATIONS

The present disclosure claims the benefit of priori to U.S. 62/722,398, filed Aug. 24, 2018, the entirety of which is incorporated by reference herein.

### FIELD

The present disclosure relates generally to order fulfillment, and, more particularly to a method and a system for facilitating delivery of parcels to users.

### BACKGROUND

Electronic commerce (e-commerce) websites have revolutionized the way users shop for items. These days users prefer ordering items online rather than going to brick and mortar stores. Increase in online shopping trend has further led to an increase in the demand of order management systems that facilitate delivery of ordered items at user specified locations.

Typically, when a user places an order for an item, the user specifies a destination location for delivering the item. After the item is properly packaged, it is shipped from the seller's location to a local storage that is located in the vicinity of the destination location specified by the user. A delivery coordinator is allocated the task of delivering the item from the local storage to the destination location. The delivery coordinator gets in touch with the user to notify the user regarding the delivery of the item. For example, the delivery coordinator may call on a contact number of the user to inform the user regarding an expected delivery time of the item. Thus, the user has to wait at the destination location at the expected delivery time in anticipation of receiving the item. However, in a situation, where the user is unavailable at the specified destination location at the expected delivery time, the attempt to deliver the item fails and the delivery coordinator has to reschedule the delivery thereby, causing inconvenience to the user and the delivery coordinator. Until subsequent delivery attempt, the item has to be stored at the local storage which results in an increase in the storage cost of the item and decrease in the efficiency and throughput of the order management system, leading to a significant loss in revenue.

In light of the foregoing, there exists a critical need for a technical and reliable solution that solves the abovementioned problems and facilitates last mile delivery of parcels to users in an efficient manner.

### SUMMARY

In an embodiment of the disclosure, a system for facilitating delivery of a first parcel to a first user is provided. The system comprises one or more automated guided vehicles (AGVs) that are stationed at a buffer storage in a multistory building. The buffer storage temporarily stores the first parcel for delivering to the first user at a first destination location. The first destination location lies within a service area associated with the buffer storage. The system further comprises an order management server that is communicatively coupled to the one or more AGVs. The order management server is configured to receive location information from a user-device of the first user. Based on the received location information, the order management server tracks real-time location of the first user. The order management server communicates a first instruction to a first AGV of the one or more AGVs to load the first parcel thereon and transit from the buffer storage to the first destination location for delivering the loaded first parcel to the first user. The first instruction is communicated based on a match between the tracked real-time location and the first destination location.

In another embodiment of the disclosure, a method for facilitating delivery of a first parcel to a first user is provided. Based on an order placed by the first user for the first parcel, an order management server determines whether the first parcel is received at a buffer storage in a multistory building. The first parcel is temporarily stored in the buffer storage for delivering to the first user at a first destination location and the buffer storage caters to the first destination location. Based on the determination that the first parcel is received at the buffer storage, location information from a user-device of the first user is received by the order management server. Based on the received location information, a real-time location of the first user is tracked by the order management server. A first instruction is communicated by the order management server to an AGV stationed at the buffer storage to load the first parcel thereon and transit from the buffer storage to the first destination location for delivering the loaded first parcel to the first user. The first instruction is communicated based on a match between the tracked real-time location and the first destination location.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates an embodiment of an exemplary environment, in accordance with an exemplary embodiment of the disclosure;

FIG. 2 is a process flow diagram that illustrates a method for storing parcels at buffer storages, in accordance with an exemplary embodiment of the disclosure;

FIGS. 3A-3F are block diagrams that collectively illustrate an exemplary scenario for facilitating delivery of parcels to users, in accordance with an exemplary embodiment of the disclosure;

FIGS. 4A-4D are block diagrams that collectively illustrate an exemplary scenario for facilitating delivery of multiple parcels in a single transit operation, in accordance with another exemplary embodiment of the disclosure;

FIG. 5 is a block diagram that illustrates an exemplary scenario for facilitating delivery of parcels to users, in accordance with another exemplary embodiment of the disclosure;

FIG. 6 is a block diagram that illustrates an exemplary scenario for facilitating delivery of parcels to users, in accordance with another exemplary embodiment of the disclosure;

FIG. 7 is a block diagram that illustrates an order management server, in accordance with an exemplary embodiment of the disclosure;

FIG. 8 is a block diagram that illustrates an automated guided vehicle (AGV), in accordance with an exemplary embodiment of the disclosure;

FIG. 9 is a block diagram that illustrates system architecture of a computer system, in accordance with an exemplary embodiment of the disclosure;

FIGS. 10A-10D, collectively represent a flow chart that illustrates a method for facilitating delivery of parcels to users, in accordance with an exemplary embodiment of the disclosure;

FIG. 11 is a flow chart that illustrates a method for facilitating delivery of parcels to users, in accordance with an exemplary embodiment of the disclosure; and

FIG. 12 is a flow chart that illustrates a method for facilitating delivery of multiple parcels in a single transit operation, in accordance with an exemplary embodiment of the disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Generally, when a delivery coordinator is out for delivering a parcel to a user, the user is notified in advance regarding an expected delivery time slot. However, the user is not aware of an exact time when the parcel will be delivered, and hence, the user has to be available for the entire duration for receiving the parcel. In a scenario where the user is unavailable to receive the parcel, the delivery coordinator has to reschedule the delivery. This increases the cost of storage of the parcel and decreases the efficiency and throughput of the order management system as delivery of the parcel needs to attempt again. Moreover, rescheduling the delivery causes inconvenience to both the user and the delivery coordinator.

Various embodiments of the disclosure provide a method and a system that solve the abovementioned problems by facilitating hassle-free last mile delivery of parcels to users. An order management server may receive an order request of a user. The user may have placed the order by using a user-device. Based on the received order request, the order management server selects a suitable storage facility for fulfilling the order. The order management server further selects a suitable buffer storage based on a destination location specified by the user for delivering a parcel associated with the order. A buffer storage corresponds to a dedicated parcel storage area for one or more buildings that lie within a specific service area, and is included in one of the associated buildings. The buffer storage temporarily stores the parcels that have destination locations within the service area of the buffer storage. The order management server selects a delivery coordinator for collecting the parcel from the selected storage facility and delivering at the selected buffer storage. When the delivery coordinator delivers the parcel at the buffer storage, the order management server facilitates the delivery of the parcel from the buffer storage to the destination location based on delivery preferences (e.g., the destination location and a scheduled delivery time) of the user and a real-time location of the user. The order management server tracks real-time location of the user, and when the real-time location of the user matches the destination location, the order management server instructs an automated guided vehicle (AGV) stationed at the buffer storage to load and deliver the parcel to the user at the destination location. The order management server further identifies a route to be followed by the AGV for delivering the parcel to the user. For delivering the parcel to the user at the destination location in a multistory building, the AGV may have to travel across different floors of the multistory building. In such a scenario, the AGV utilizes one or more elevators present in the multistory building for traveling across different floors. The order management server may communicate an estimated time of delivery to the user through the user-device. In one embodiment, the order management server may optimize parcel delivery by clubbing delivery of multiple parcels in a single transit operation of the AGV.

Thus, the method and system facilitate last mile deliveries of parcels based on preferences of the user and the real-time location of the user, thereby decreasing the number of failed deliveries and increasing the efficiency and throughput of the order management server.

In some embodiments, a “parcel” may refer to an item ordered by a user. For example, when the user places an order for delivery of an item, the item is packed at a storage facility and shipped to the user as a parcel.

In some embodiments, an “AGV” is a robotic vehicle that is stationed at a buffer storage for executing one or more parcel delivery operations based on instructions received from an order management server. For example, the AGV may load a parcel thereon and transit from the buffer storage to a destination location for delivering the loaded parcel to a user at the destination location.

In some embodiments, a “buffer storage” may be a local storage area to temporarily store parcels. The buffer storage may include one or more AGVs for delivering parcels to various users at their respective destination locations. The buffer storage may be located in a multistory building and may cater to a specific service area. For example, the buffer storage may be located on a ground floor of a multistory building.

In some embodiments, an “order management server” is a physical or cloud data processing system on which a server program runs. The control server may be implemented in hardware or software, or a combination thereof. In one embodiment, the control server may be implemented in computer programs executing on programmable computers, such as personal computers, laptops, or a network of computer systems. The order management server is configured to facilitate deliveries of parcels to various users at their respective destination locations.

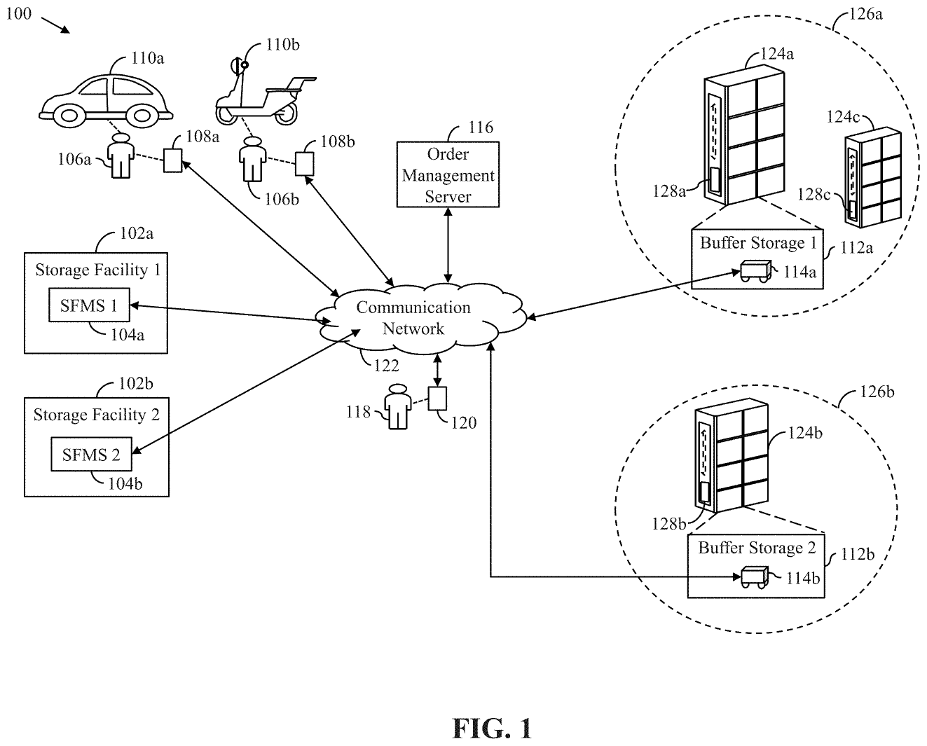

FIG. 1 is a block diagram that illustrates an embodiment of an exemplary environment 100, in accordance with an exemplary embodiment of the disclosure. The environment 100 includes storage facilities 102 (e.g., first and second storage facilities 102a and 102b) that are managed by storage facility management servers (SFMS) 104 (e.g., first and second SFMSs 104a and 104b). The environment 100 further includes delivery coordinators 106 (e.g., first and second delivery coordinators 106a and 106b) in possession of mobile-devices 108 (e.g., first and second mobile-devices 108a and 108b) and delivery vehicles 110 (e.g., first and second delivery vehicles 110a and 110b). The environment 100 further includes buffer storages 112 (e.g., first and second buffer storages 112a and 112b), AGVs 114 (e.g., first and second AGVs 114a and 114b), and an order management server 116. The environment 100 further includes a first user 118 in possession of a first user-device 120. The SFMSs 104, the mobile-devices 108, the AGVs 114, the order management server 116, and the first user-device 120 communicate with each other via a communication network 122.

The storage facilities 102 store items for fulfillment of orders. Examples of the storage facilities 102 may include retail stores, forward warehouses, and/or backward warehouses. The items in the storage facilities 102 may be categorized into various categories and stored in storage units of the storage facilities 102. In one exemplary scenario, the storage units are organized in various departments based on categories of the items stored in the storage units. For example, a first set of storage units may form a first department (i.e., a food department) and a second set of storage units may form a second department (i.e., an apparels department).

The SFMSs 104 are configured to manage various operations performed at the storage facilities 102. For example, the first SFMS 104a manages the operations performed at the first storage facility 102a and the second SFMS 104b manages the operations performed at the second storage facility 102b. The operations performed at the storage facilities 102 may include sorting the items based on their categories, storing the items in the storage units, retrieving the items from the storage units for order fulfillment, or the like. The SFMSs 104 are configured to receive order requests from the order management server 116 for orders placed by various users. For example, the first SFMS 104a may receive a first order request from the order management server 116 for a first order placed by the first user 118. The first order request may include details of a first item, an order identifier (ID), or the like. Based on the first order request, the first SFMS 104a may facilitate packaging of the first item for fulfilling the order. Hereinafter, a packed item that is ready for delivery is referred to as a “parcel”.

The delivery coordinators 106 are delivery persons who receive delivery requests from the order management server 116 on their respective mobile-devices 108. Examples of the mobile-devices 108 may include a smartphone, a personal computer, a tablet, a phablet, or the like. For example, the first mobile-device 108a may receive a first delivery request from the order management server 116 for the delivery of a first parcel. The first delivery request may include details of the first parcel, a source location from where the first parcel is to be collected, an order ID associated with the first parcel, a buffer storage location for delivering the first parcel, or the like. Based on the received delivery requests, the delivery coordinators 106 transit to respective source locations using the corresponding delivery vehicles 110 for collecting parcels. The delivery vehicles 110 are transport vehicles used by the delivery coordinators 106 for delivering parcels from source locations to respective buffer storage locations. Examples of the delivery vehicles 110 may include, but are not limited to a bus, a car, a bike, a bicycle, or the like. After collecting the parcels, the delivery coordinators 106 transit to the respective buffer storage locations for delivering the collected parcels.

The buffer storages 112 are last mile storage areas where the parcels may be temporarily stored before being delivered to corresponding users. The buffer storages 112 include storage units for storing the parcels temporarily. Last mile delivery of a parcel includes, for example, delivering the parcel from a buffer storage (e.g., the first or second buffer storage 112a or 112b) to a destination location specified by a user. Each buffer storage 112 may be included in a multistory building and caters to one or more corresponding service areas. As shown in FIG. 1, the first and second buffer storages 112a and 112b are included in first and second multistory buildings 124a and 124b and cater to first and second service areas 126a and 126b, respectively. In one embodiment, a single buffer storage may cater to a single multistory building. For example, the second buffer storage 112b caters to the second multistory building 124b within which the second buffer storage 112b is located. In another embodiment, a single buffer storage may cater to multiple multistory buildings that lie within the service area of the buffer storage. For example, the first buffer storage 112a caters to the first multistory building 124a and a third multistory building 124c that lie within the first service area 126a. The first buffer storage 112a temporarily stores those parcels for which the destination location is in one of the first and third multistory buildings 124a and 124c. Likewise, the second buffer storage 112b temporarily stores those parcels for which the destination location is in the second multistory building 124b.

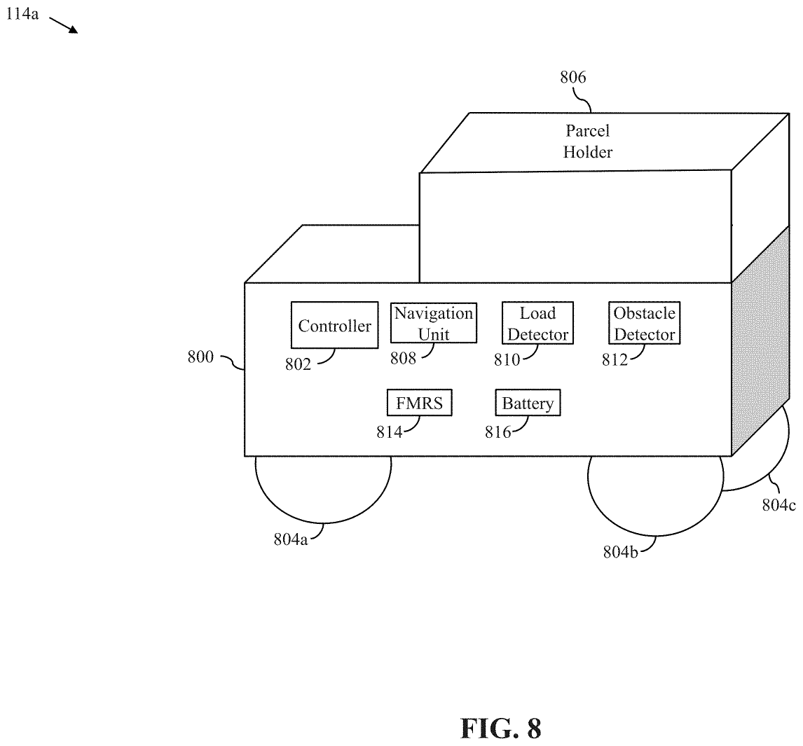

The AGVs 114 may include suitable logic, instructions, circuitry, interfaces, and/or codes, executable by the circuitry, for executing various operations, such as delivering parcels at the specified destinations of the users. In some embodiments, the AGVs 114 are robotic vehicles that are stationed at the buffer storages 112. For example, the first AGV 114a is stationed at the first buffer storage 112a and the second AGV 114b is stationed at the second buffer storage 112b. The AGVs 114 load the parcels stored at the corresponding buffer storages 112 for delivering the loaded parcels to the respective users. After loading the parcels, the AGVs 114 transit from the corresponding buffer storages 112 to last mile destination locations for delivering the parcels. For example, the first AGV 114a may load a parcel stored at the first buffer storage 112a and transit from the first buffer storage 112a to a first floor of the first multistory building 124a for delivering the first parcel to a user. The AGVs 114 are configured to respond to instructions of the order management server 116 for delivering the parcels to the users. The AGVs 114 are configured to utilize elevators 128 of the corresponding multistory buildings 124 to transit across different floors of the corresponding multistory buildings 124. For example, the first AGV 114a may utilize a first elevator 128a of the first multistory building 124a to transit across different floors of the first multistory building 124a for delivering parcels. Likewise, the second AGV 114b may utilize a second elevator 128b of the second multistory building 124b to transit across different floors of the second multistory building 124b for delivering parcels. Embodiments of various components of the AGVs 114 and their functionalities are described later in conjunction with FIG. 8.

In one embodiment, dimensions of a service area that a buffer storage is capable of catering to, is based on various factors such as, a storage capacity of the buffer storage, a count of AGVs that are stationed at the buffer storage, capacities of the AGVs stationed at the buffer storage, or the like. For example, the dimensions of the first service area 126a that the first buffer storage 112a is capable of catering to, is based on a storage capacity of the first buffer storage 112a, a count of AGVs that are stationed at the first buffer storage 112a, a capacity of the first AGV 114a stationed at the first buffer storage 112a, or the like. The capacity of the first AGV 114a may indicate load and size carrying capacity of the first AGV 114a. Likewise, the dimensions of the second service area 126b that the second buffer storage 112b is capable of catering to, is based on a storage capacity of the second buffer storage 112b, a count of AGVs that are stationed at the second buffer storage 112b, a capacity of the second AGV 114b stationed at the second buffer storage 112b, or the like.

The order management server 116 includes suitable logic, circuitry, interfaces, and/or code, executed by the circuitry, for managing orders placed by various users. The order management server 116 is configured to receive order requests from user-devices of users. For example, the order management server 116 may receive the first order request from the first user-device 120 for a first order placed by the first user 118. Based on the first order request, the order management server 116 is configured to select a suitable storage facility from the storage facilities 102 to cater to the first order request. The order management server 116 may select the storage facility based on an availability of a first item of the first order, a cost of retrieving the first item from the storage facility, or the like. The order management server 116 is further configured to communicate the first order request to a SFMS (e.g., the SFMSs 104) of the selected storage facility for fulfilling the first order. The order management server 116 is further configured to select, from the buffer storages 112, a buffer storage that is associated with a destination location specified by the first user 118. The order management server 116 is further configured to select one of the delivery coordinators 106 for delivering the first parcel from the selected storage facility to the selected buffer storage. The order management server 116 may select the delivery coordinator based on parameters such as, a cost of transiting, a time for transiting, or the like. The order management server 116 is configured to communicate the first delivery request to a mobile-device of the selected delivery coordinator for instructing the selected delivery coordinator to deliver the first parcel from the selected storage facility to the selected buffer storage. In one embodiment, the order management server 116 may be configured to receive location information from the mobile-device of the selected delivery coordinator. Based on the location information received from the mobile-device, the order management server 116 may be configured to track a real-time location of the selected delivery coordinator for tracking a progress status of the first order.

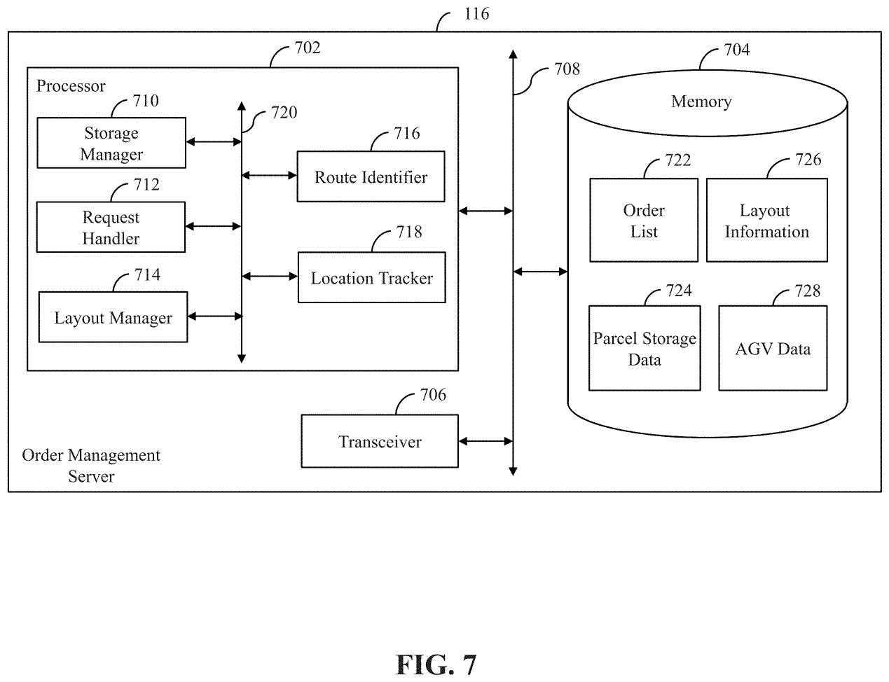

When the selected delivery coordinator delivers the first parcel at the selected buffer storage, the order management server 116 may receive a notification from the mobile-device of the selected delivery coordinator indicating that the first parcel is delivered and temporarily stored at the selected buffer storage. The order management server 116 is further configured to receive location information from the first user-device 120. Based on the location information received from the first user-device 120, the order management server 116 may track a real-time or a near-real time location of the first user 118 for facilitating the delivery of the first parcel at the destination location specified by the first user 118. Embodiments of various components of the order management server 116 and their functionalities are described later in conjunction with FIG. 7.

The first user-device 120 includes suitable logic, circuitry, interfaces, and/or code, executed by the circuitry, for enabling the first user 118 to place orders for purchasing items. Examples of the first user-device 120 may include a smartphone, a personal computer, a tablet, a phablet, or the like. The first user-device 120 may be a global positioning system (GPS) enabled device that is configured to communicate corresponding location information to the order management server 116. The first user-device 120 may be utilized by the first user 118 to check the progress status of the placed order.

The communication network 122 is a medium through which content and messages are transmitted between the SFMSs 104, the mobile-devices 108, the AGVs 114, the order management server 116, and the first user-device 120. Examples of the communication network 122 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 122 in accordance with various wired and wireless communication protocols, such as Transmission Control Protocol and Internet Protocol (TCP/IP), User Datagram Protocol (UDP), Long Term Evolution (LTE) communication protocols, or any combination thereof.

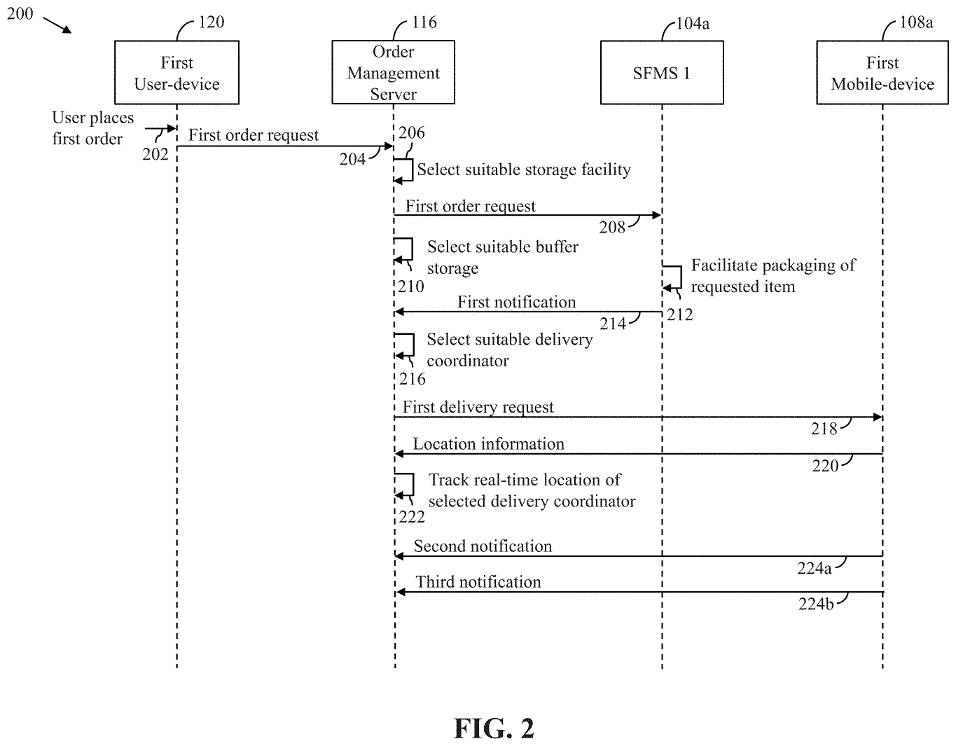

FIG. 2 is a process flow diagram 200 that illustrates a method for storing parcels at the buffer storages 112, in accordance with an exemplary embodiment of the disclosure. The process flow diagram 200 involves the first SFMS 104a, the first mobile-device 108a, the first buffer storage 112a, the order management server 116, and the first user-device 120.

The first order is placed by the first user 118 using the first user-device 120 (as shown by arrow 202). The order management server 116 receives the first order request from the first user-device 120 (as shown by arrow 204). The order management server 116 selects a suitable storage facility from the storage facilities 102 to cater to the first order request. The order management server 116 may select the suitable storage facility based on various factors such as, an availability of the requested item, nearness to a first destination location specified by the first user 118, order handling capacity of the storage facilities 102, or the like. In one example, the order management server 116 may determine that the requested item is only available at the first storage facility 102a. In another example, the order management server 116 may determine that the first storage facility 102a is nearest to the first destination location specified by the first user 118 for receiving the requested item. In yet another example, the order management server 116 may determine that the order handling capacity of the first storage facility 102a is Optimum. Thus, the order management server 116 selects the first storage facility 102a to cater to the first order request (as shown by arrow 206). The order management server 116 then communicates the first order request to the first SFMS 104a associated with the selected first storage facility 102a (as shown by arrow 208). The order management server 116 further selects a suitable buffer storage from the buffer storages 1112 that is associated with the first destination location specified by the first user 118. For example, the order management server 116 may determine that the first destination location specified by the first user 118 lies in the first service area 126a of the first buffer storage 112a, and thus, the order management server 116 selects the first buffer storage 112a for temporarily storing the requested item (as shown by arrow 210).

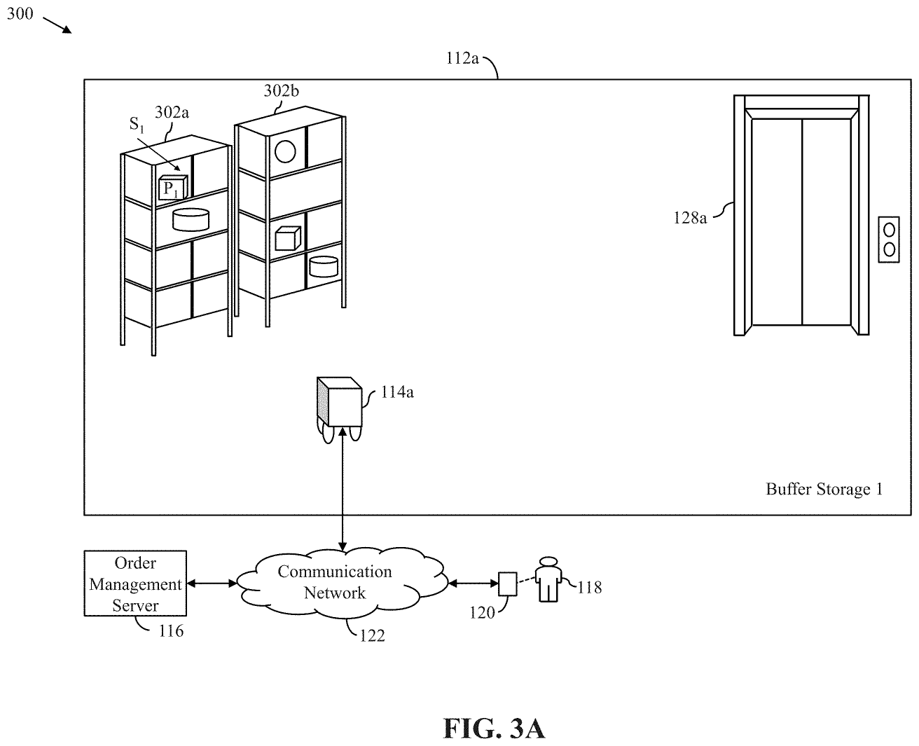

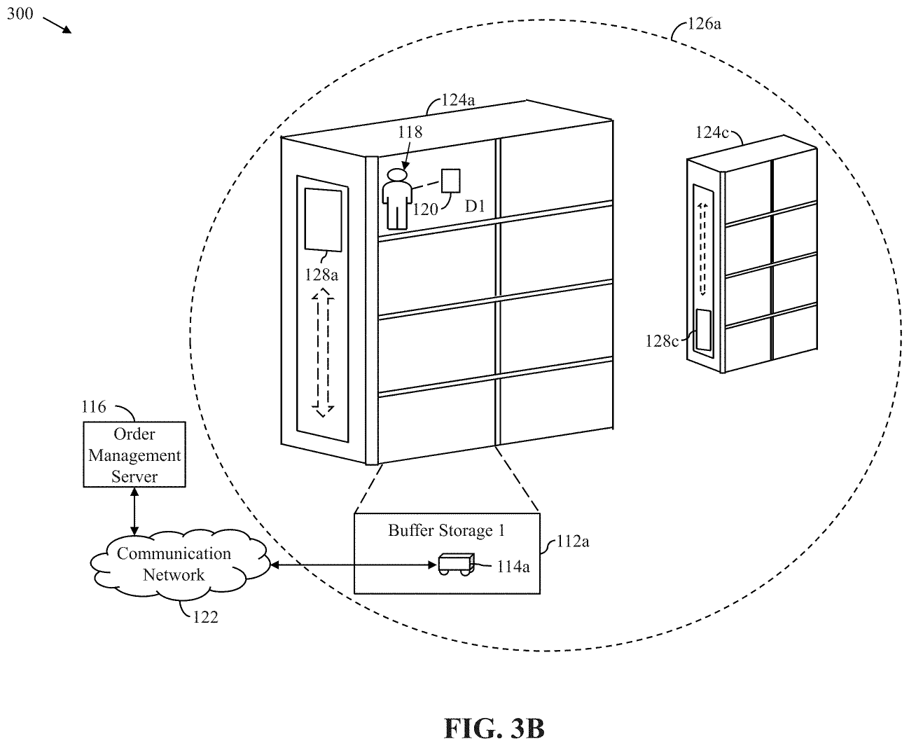

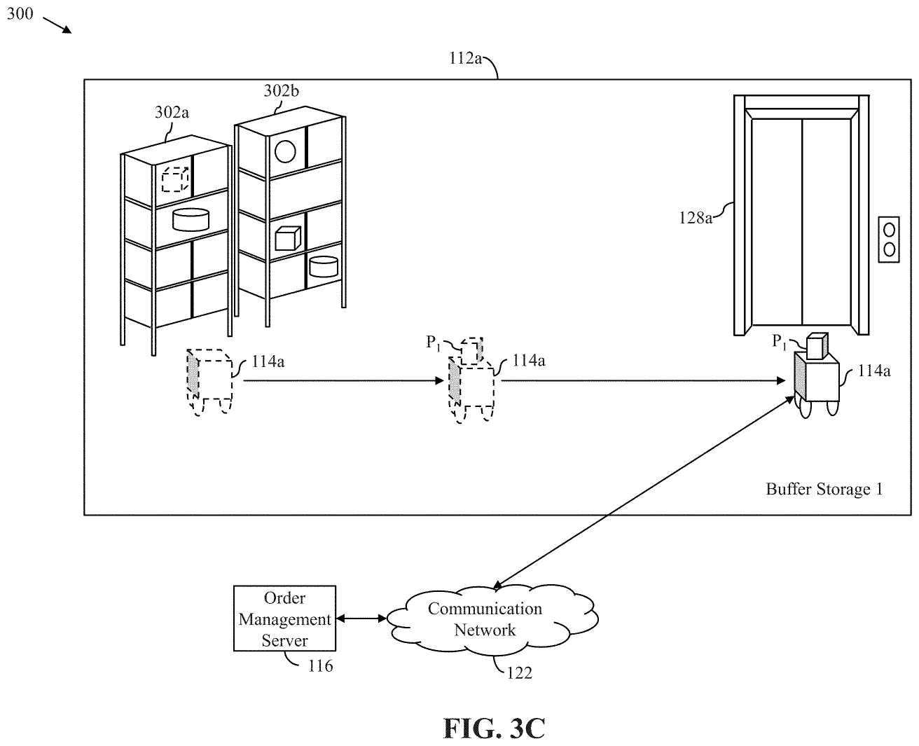

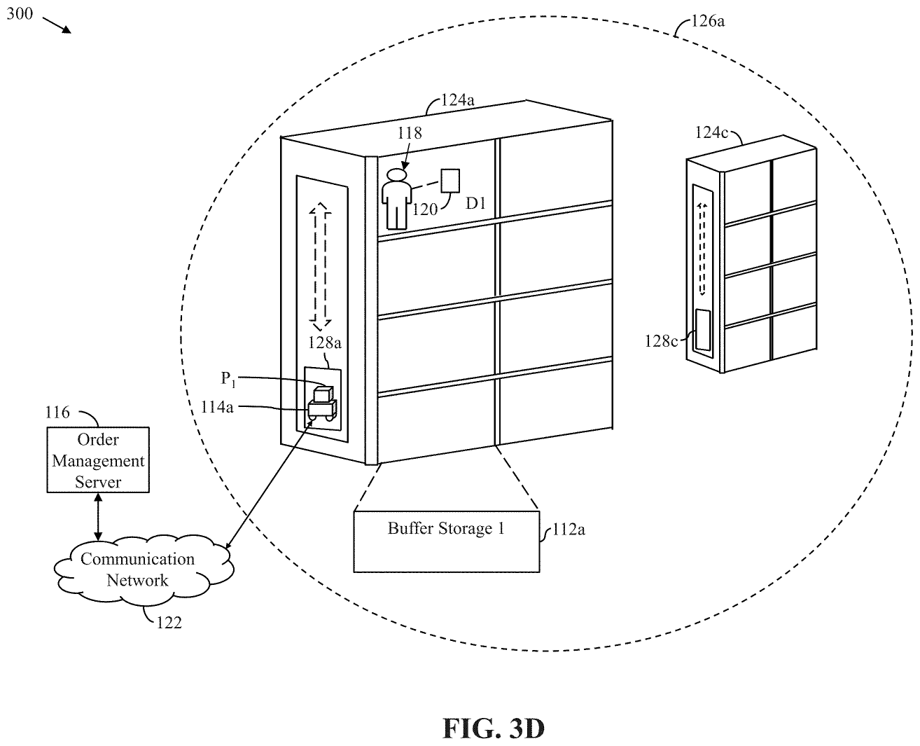

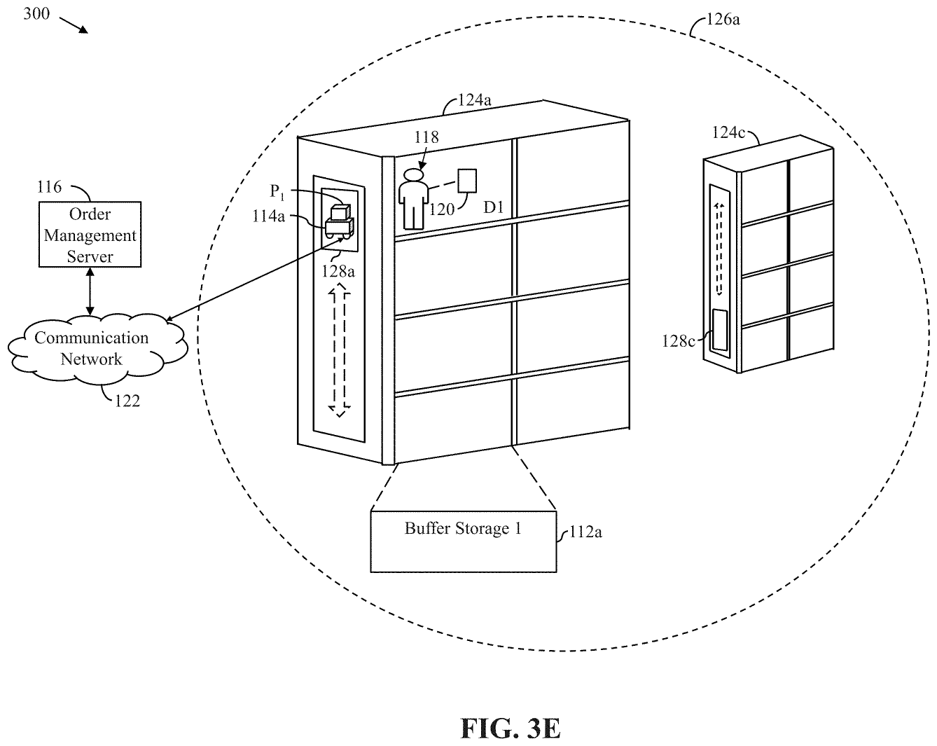

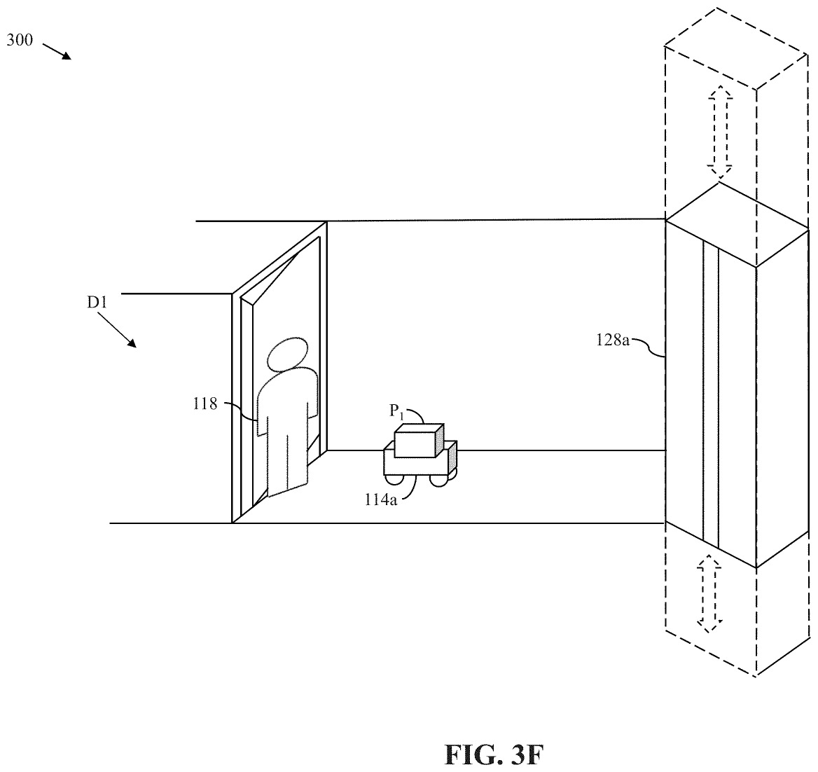

The first SFMS 104a receives the first order request and facilitates the packaging of the requested item (as shown by arrow 212). The packed item is hereinafter referred to and designated as a “first parcel P₁” (as shown in FIGS. 3A-3F). When the requested item is packed and ready for delivery, the first SFMS 104a communicates a first notification to the order management server 116 indicating that the first parcel P₁ is ready for delivery (as shown by arrow 214). The order management server 116 receives the first notification and selects a suitable delivery coordinator from the delivery coordinators 106 for collecting the first parcel P₁ from the first storage facility 102a and delivering it to the first buffer storage 112a. The order management server 116 may select the suitable delivery coordinator based on various factors such as, availability of the delivery coordinators 106, nearness to the selected storage facility, or the like. In one example, the order management server 116 may determine that from the delivery coordinators 106 only the first delivery coordinator 106a is currently available. In another example, the order management server 116 may determine that the first delivery coordinator 106a is nearest to the first storage facility 102a for collecting the first parcel P₁ associated with the first order. Thus, the order management server 116 selects the first delivery coordinator 106a (as shown by arrow 216).

The order management server 116 further communicates the first delivery request to the first mobile-device 108a of the first delivery coordinator 106a (as shown by arrow 218). The order management server 116 may further communicate a request to the first mobile-device 108a for receiving location information of the first mobile-device 108a. Based on the received request, the first mobile-device 108a, which is a GPS enabled device, may communicate location information to the order management server 116. The order management server 116 receives the location information from the first mobile-device 108a (as shown by arrow 220), and tracks the progress status of the first order by tracking the real-time location of the first delivery coordinator 106a (as shown by arrow 222). The Location information may be directed by the user handling the first mobile device 108 a and various mechanisms may be placed so as to ensure that the location information is not transferred without the consent of the user 118.

When the first delivery coordinator 106a collects the first parcel P₁ from the first storage facility 102a, the order management server 116 receives a second notification from the first mobile-device 108a (as shown by arrow 224a). The second notification indicates that the first parcel P₁ is collected from the first storage facility 102a. When the first delivery coordinator 106a delivers the first parcel P₁ at the first buffer storage 112a, the order management server 116 receives a third notification from the first mobile-device 108a (as shown by arrow 224b). The third notification indicates that the first parcel P₁ is delivered at the first buffer storage 112a. The first parcel P₁ is then temporarily stored at the first buffer storage 112a. The process of facilitating the last mile delivery of the first parcel P₁ from the first buffer storage 112a to the first destination location specified by the first user 118 is explained in conjunction with FIGS. 3A-3F.

FIGS. 3A-3F are block diagrams that collectively illustrate an exemplary scenario 300 for facilitating delivery of parcels to users, in accordance with an exemplary embodiment of the disclosure. FIGS. 3A-3F are described in conjunction with FIG. 2.

With reference to FIG. 3A, the first buffer storage 112a includes storage units 302 (e.g., first and second storage units 302a and 302b) for temporarily storing parcels (e.g., the first parcel P₁). The first buffer storage 112a further includes the first AGV 114a and an access to the first elevator 128a.

The storage units 302 are used to temporarily store parcels received at the first buffer storage 112a. The storage units 302 may include shelves and slots to store the parcels therein. When the first delivery coordinator 106a delivers the first parcel P₁ at the first buffer storage 112a, the order management server 116 is configured to determine a slot in the storage units 302 for temporarily storing the first parcel P₁. The order management server 116 may determine the slot based on a size of the first parcel P₁, a weight of the first parcel P₁, dimensions of the first parcel P₁, a center of gravity of each of the storage units 302, or the like. As shown in FIG. 3A, the order management server 116 may select a first slot S₁ of the first storage unit 302a for storing the first parcel P₁. In one embodiment, the order management server 116 may communicate an instruction to an operator device (not shown) of an operator (not shown) in the first buffer storage 112a for storing the first parcel P₁ delivered by the first delivery coordinator 106a in the first slot S₁. In another embodiment, the order management server 116 may communicate an instruction to the first AGV 114a for receiving the first parcel P₁ from the first delivery coordinator 106a and storing the first parcel P₁ in the first slot S₁. Based on the instruction, the first AGV 114a receives the first parcel P₁ from the first delivery coordinator 106a and stores the first parcel P₁ in the first slot S₁. On the delivery of the first parcel P₁ at the first buffer storage 112a, the order management server 116 may determine whether the first user 118 has provided delivery preferences for delivering the first parcel P₁. For example, the order management server 116 may determine that the first user 118 has scheduled a delivery time for delivering the first parcel P₁ at the first destination location.

In one embodiment, the first user 118 may not have scheduled a delivery time for delivering the first parcel P₁. In such a scenario, the order management server 116 is configured to communicate a request to the first user-device 120 for tracking a real-time location of the first user 118. The first user 118 may accept the request and may allow the order management server 116 to track the real-time location of the first user 118. Based on the acceptance of the request, the first user-device 120 is configured to communicate location information of the first user-device 120 to the order management server 116 at periodic intervals (e.g., after every five seconds). The order management server 116 receives the location information from the first user-device 120. Based on the received location information, the order management server 116 is configured to track the real-time location of the first user 118. For example, the location information may include location coordinates of the first user-device 120. Since the first user-device 120 communicates the location information to the order management server 116 at periodic intervals, any change in the location coordinates may indicate a change in the location of the first user 118. The order management server 116 is configured to determine whether the tracked real-time location of the first user 118 matches the first destination location where the delivery of the first parcel P₁ is to be made. The order management server 116 continues to track the real-time location of the first user 118 until the real-time location matches the first destination location.

In another embodiment, the first user 118 may have scheduled a delivery time for delivering the first parcel P₁. In such a scenario, the order management server 116 may be configured to track the real-time location of the first user 118 at the scheduled delivery time. For example, the first user 118 may have scheduled the delivery of the first parcel P₁ between 3 PM to 5 PM. Thus, the order management server 116 may track the real-time location of the first user 118 between 3 PM to 5 PM.

With reference to FIG. 3B, based on the received location information at a current time instance, the order management server 116 may determine that the first user 118 is present at a location “D1” in the first multistory building 124a. When the location “D1” is the first destination location where the delivery of the first parcel P₁ is to be made, the order management server 116 determines that the tracked real-time location of the first user 118 matches the first destination location. Based on a match between the tracked real-time location and the first destination location, the order management server 116 is configured to select a suitable AGV from one or more AGVs stationed at the first buffer storage 112a. The order management server 116 may select the AGV based on various parameters such as, the size of the first parcel P₁, the weight of the first parcel P₁, the shape of the first parcel P₁, the dimensions of the first parcel P₁, a material of the first parcel P₁, the load and size carrying capacity of the one or more AGVs, or the like. In one example, the order management server 116 may determine that the load and size carrying capacity of the first AGV 114a is sufficient to cater to the first parcel P₁, thus the order management server 116 selects the first AGV 114a. Furthermore, the order management server 116 may take into account any other delivers that an AGV would have to perform while carrying the first parcel P₁.

In some embodiments, the order management server 116 further determines an optimized route to be traversed by the first AGV 114a from the first buffer storage 112a to the first destination location “D1” for delivering the first parcel P₁ to the first user 118. In one exemplary scenario, there may be two routes to reach the first destination location “D1” from the first buffer storage 112a. In such a scenario, the order management server 116 may determine various parameters associated with each route, for example, a time taken to transit each route, a number of obstacles in each route, a difficulty score for the selected AGV to transit each route, or the like. Based on the determined parameters, the order management server 116 is configured to select the optimal route for the first AGV 114a. The order management server 116 is configured to estimate a first time of delivery for delivering the first parcel P₁ to the first user 118. The first time of delivery corresponds to a time by when the first parcel P₁ will be delivered to the first user 118 by the first AGV 114a by traversing the selected route. The order management server 116 may estimate the first time of delivery based on a distance of the selected route, a speed of the first AGV 114a, a weight carried by the first AGV 114a, a response time of the first elevator 128a, or the like. For example, the time taken to load the first parcel P₁ on the first AGV 114a may be 2 minutes, the time taken by the first AGV 114a to reach the access point of the first elevator 128a after the first parcel P₁ is loaded may be 5 minutes, the transit time in the first elevator 128a may be 10 minutes, and the time taken by the first AGV 114a to exit the first elevator 128a and reach at the first destination location “D1” may be 3 minutes. Thus, the total time taken for delivering the first parcel P₁ to the first user 118 is 20 minutes (i.e., 2+5+10+3=20 minutes). In such a scenario, if the current time is 3 PM, the estimated first time of delivery is 3:20 PM. In another exemplary scenario, if the first parcel P₁ is to be delivered in the third multistory building 124c that lies in the first service area 126a, the order management server 116 may also utilize the time taken to transit from the first multistory building 124a to the third multistory building 124c for estimating the first time of delivery. The order management server 116 is further configured to communicate information pertaining to the estimated first time of delivery to the first user-device 120 for notifying the first user 118 regarding the delivery of the first parcel P₁.

The order management server 116 is further configured to communicate a first instruction to the first AGV 114a. Based on the first instruction, the first AGV 114a is instructed to load the first parcel P₁ thereon from the first storage unit 302a for delivering to the first user 118 at the first destination location “D1”. The first instruction may include information pertaining to the order ID of the first parcel P₁ for identifying the first parcel P₁ in the first storage unit 302a, the slot S₁, the determined route, the first destination location “D1”, and the estimated first time of delivery. For example, the first instruction may include navigation coordinates of the determined route. Thus, the order management server 116 communicates the first instruction to the first AGV 114a by taking into consideration the delivery preferences of the first user 118 and the parameters associated with the first parcel P₁ and the first AGV 114a (e.g., the size of the first parcel P₁, the weight of the first parcel P₁, the dimensions of the first parcel P₁, the load and size carrying capacity of the first AGV 114a).

With reference to FIG. 3C, the first AGV 114a is configured to receive the first instruction from the order management server 116. Based on the first instruction, the first AGV 114a transits from a current location of the first AGV 114a for loading the first parcel P₁ thereon. For example, based on the first instruction, the first AGV 114a reaches at a location of the first storage unit 302a at a first time-instance (i.e., t=t₁) and identifies the slot S₁ where the first parcel P₁ is temporarily stored. The first AGV 114a further identifies the first parcel P₁ based on the order ID of the first parcel P₁. After the first parcel P₁ is identified by the first AGV 114a, the first AGV 114a loads the first parcel P₁ thereon. In another embodiment, the first parcel P₁ may be loaded on the first AGV 114a by the operator (e.g., a robotic operator or a human operator). The first AGV 114a may be further configured to detect whether the first parcel P₁ is loaded thereon. After the first AGV 114a detects that the first parcel P₁ is successfully loaded, the first AGV 114a transits towards the access of the first elevator 128a based on the determined route included in the first instruction. In one embodiment, the first AGV 114a may be configured to read fiducial markers of the first multistory building 124a to move from one location to other location in the first multistory building 124a. In such a scenario, the navigation coordinates included in the first instruction correspond to various fiducial markers that are included in the determined route. As shown in FIG. 3C, at a second time instance (i.e., at t=t₂), the first AGV 114a reaches at an intermediate location between the first storage unit 302a and the access to the first elevator 128a, and at a third time instance (i.e., at t=t₃), the first AGV 114a reaches in front of the first elevator 128a for exiting the first buffer storage 112a. The first AGV 114a then utilizes the first elevator 128a to transit across different floors of the first multistory building 124a and reach the first destination location “D1” for delivering the first parcel P₁ to the first user 118.

With reference to FIG. 3D, the first AGV 114a is shown to have entered the first elevator 128a for delivering the first parcel P₁ to the first user 118. With reference to FIG. 3E, the first AGV 114a is shown to have reached a fourth floor of the first multistory building 124a by way of the first elevator 128a. The first destination location “D1” is at the fourth floor of the first multistory building 124a.

With reference to FIG. 3F, the first AGV 114a is shown to have exited the first elevator 128a. After exiting the first elevator 128a, the first AGV 114a transits towards the first destination location “D1”, for example, a doorstep of the residence of the first user 118. When the first AGV 114a reaches at the first destination location “D1”, the order management server 116 may notify the first user 118 to collect the first parcel P₁ from the first AGV 114a. Thus, the first parcel P₁ is unloaded by the first user 118. When the first AGV 114a detects that the first parcel P₁ is unloaded, the first AGV 114a is further configured to communicate a delivery notification to the order management server 116 indicating that the first parcel P₁ is successfully delivered to the first user 118 at the first destination location “D1”. In some embodiments, if the user is unavailable, the first AGV 114a may be configured to automatically unload (e.g., through a lifting device on the AGV) the parcel at a predetermined position (e.g., doorstep of the user). The first AGV 114a then returns to the first buffer storage 112a using the first elevator 128a. In one embodiment, the first AGV 114a may follow the same route for returning to the first buffer storage 112a. In another embodiment, the first AGV 114a may follow a different route, as determined by the order management server 116 for returning to the first buffer storage 112a.

As the order management server 116 continuously tracks the real-time location of the first user 118, the delivery of the first parcel P₁ is attempted when the real-time location of the first user 118 matches the first destination location “D1” specified by the first user 118. Thus, a wait time of the first user 118 is reduced. In addition, a likelihood of a situation where the first user 118 is unavailable, when the delivery of the first parcel P₁ is attempted, is minimized. Thus, increasing order delivery efficiency and throughput of the order management server 116 in comparison to conventional order delivery systems and reducing a storage cost factor associated with prolonged storage of the first parcel P₁.

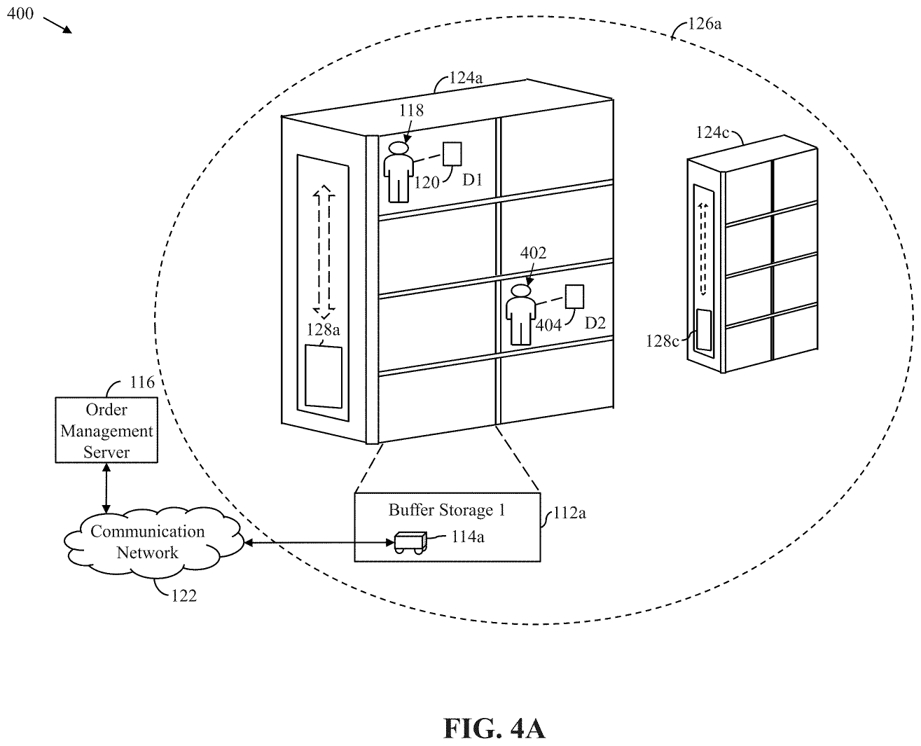

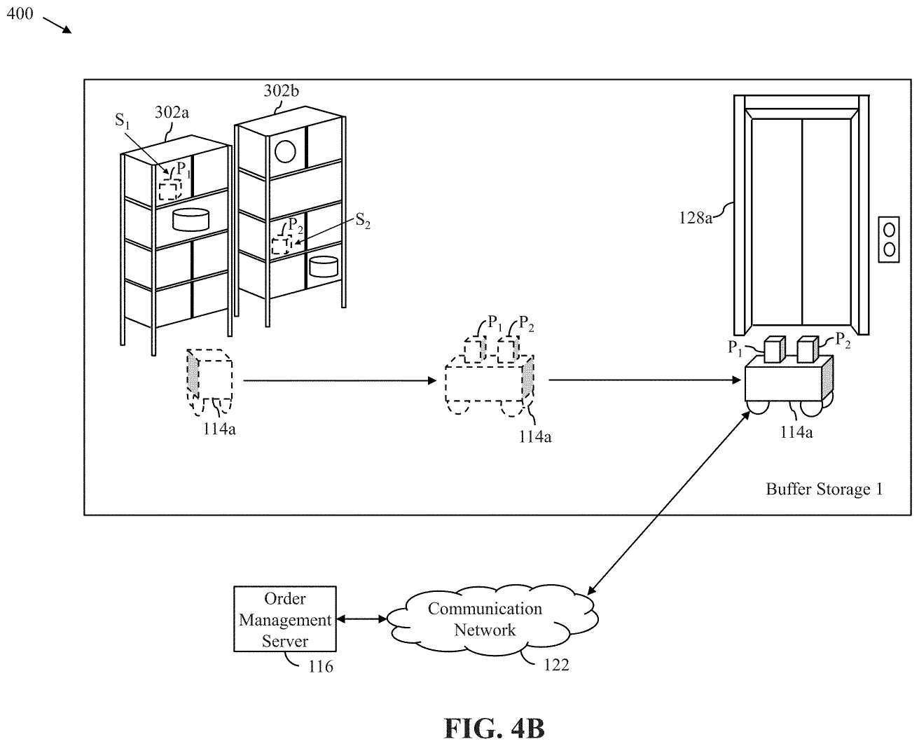

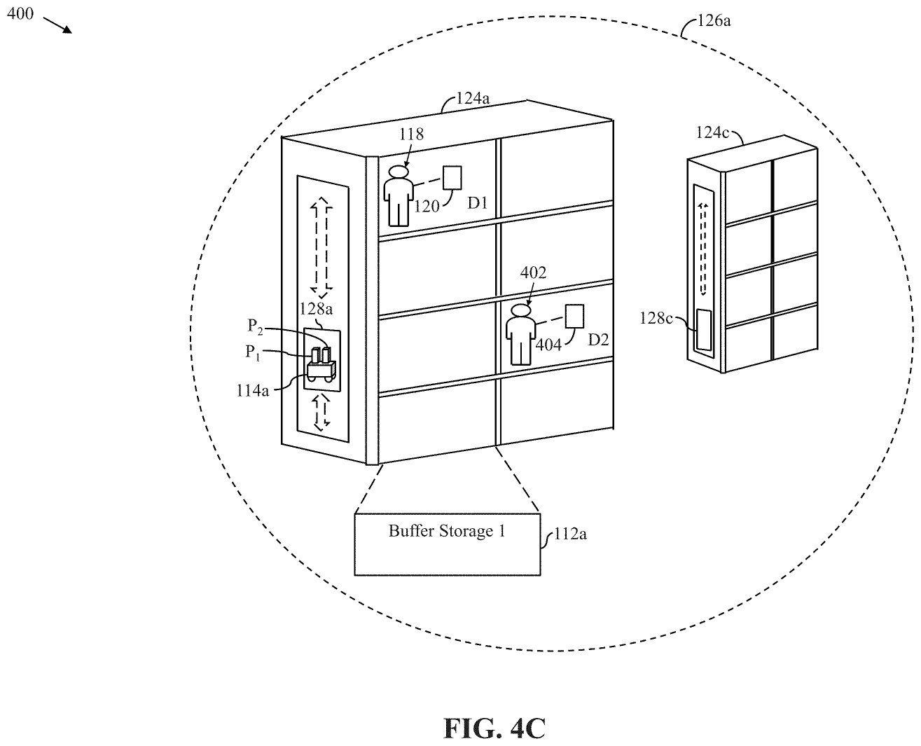

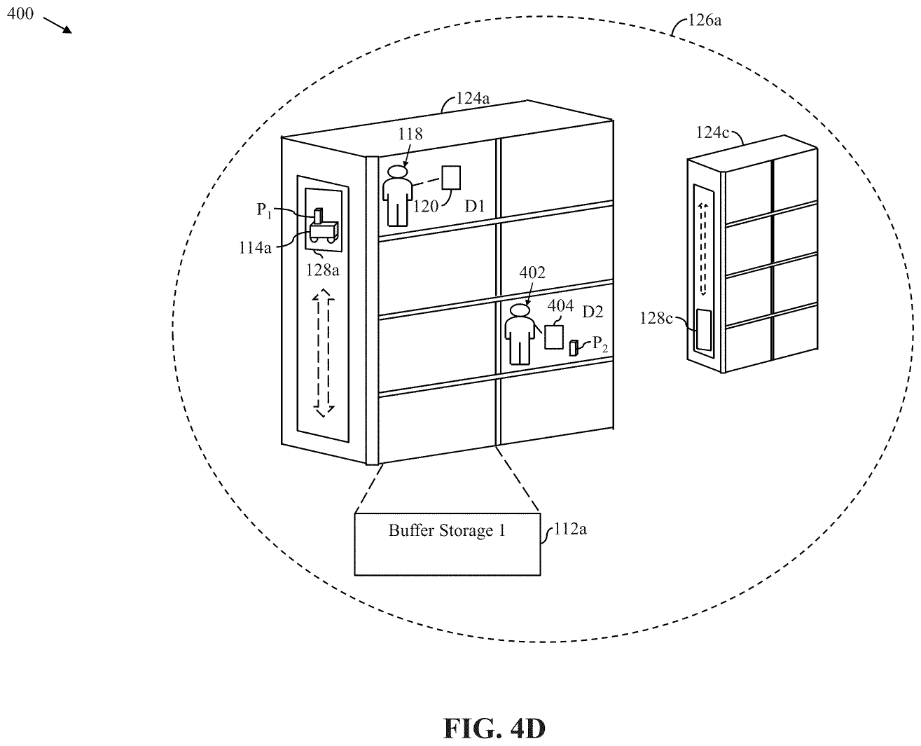

In one embodiment, the order management server 116 may optimize the delivery of parcels by causing the first AGV 114a to deliver multiple parcels to corresponding users in a single transit operation. An exemplary scenario for facilitating delivery of multiple parcels in a single transit operation is described in detail in FIGS. 4A-4D.

FIGS. 4A-4D are block diagrams that collectively illustrate an exemplary scenario 400 for facilitating delivery of multiple parcels in a single transit operation, in accordance with another exemplary embodiment of the disclosure.

With reference to FIG. 4A, the order management server 116 may have received two order requests for orders placed by the first user 118 and a second user 402. The second user 402 may have utilized a second user-device 404 for placing the corresponding order. It will be apparent to those of skill in the art that the second user-device 404 is functionally similar to the first user-device 120. The first user 118 may have specified the first destination location “D1” for delivering the first parcel P₁ and the second user 402 may have specified a second destination location “D2” for delivering a second parcel P₂. For the sake of brevity, it is assumed that the first and second destination locations “D1” and “D2” are located in the first multistory building 124a. The order management server 116 may facilitate the delivery of the first and second parcels P₁ and P₂ to the first and second users 118 and 402 respectively, in a similar manner as described in the foregoing description of FIG. 3A. It may be understood that the vehicle can travel to multiple buildings also.

The order management server 116 is configured to track the real-time locations of the first and second users 118 and 402. In some embodiments, the order management server 116 may determine that the current locations of the first and second users 118 and 402 match the first and second destination locations “D1” and “D2”, respectively. In such a scenario, the order management server 116 is configured to facilitate the delivery of both the parcels P₁ and P₂ in a single transit operation.

In some embodiments, the order management server 116 determines an optimum route (e.g., a shortest route) that caters to both the first and second destination locations “D1” and “D2”. The order management server 116 further estimates the first time of delivery and a second time of delivery for delivering the first and second parcels P₁ and P₂ to the first and second users 118 and 402, respectively. The order management server 116 further communicates the estimated first time of delivery and the second time of delivery to the first and second users 118 and 402, respectively. The order management server 116 further selects an AGV in the first buffer storage 112a that is capable of simultaneously handling both the first and second parcels P₁ and P₂. For example, the order management server 116 selects the first AGV 114a. The order management server 116 then communicates the first instruction and a second instruction to the first AGV 114a for instructing the first AGV 114a to load the first and second parcels P₁ and P₂ from the first storage unit 302a. The first and second instructions may include information pertaining to the order IDs of the first and second parcels P₁ and P₂, slots S₁ and S₂ that respectively store the first and second parcels P₁ and P₂, the determined route, the first and second destination locations “D1” and “D2”, and the first and second times of delivery.

In one embodiment, the first and second users 118 and 402 may have scheduled the delivery of the respective parcels P₁ and P₂. In such a scenario, the order management server 116 may join or combine the delivery of the first and second parcels P₁ and P₂ in a single transit operation when the scheduled delivery times for the first and second parcels P₁ and P₂ is separated by at least a threshold value (i.e., a difference between the first and second times of delivery). For example, the estimated first time of delivery may be 3 PM and the estimated second time of delivery may be 3:15 PM. Thus, if the scheduled delivery times for both the parcels P₁ and P₂ is 3 PM, the order management server 116 may not club the delivery of the first and second parcels P₁ and P₂, and may instruct two different AGVs for delivering the first and second parcels P₁ and P₂. However, if the scheduled delivery times for both the parcels P₁ and P₂ are 3 PM and 3:25 PM, respectively, the order management server 116 may club the delivery of the first and second parcels P₁ and P₂ in a single transit operation. In such a scenario, the order management server 116 may further determine the route such that the first parcel P₁ is delivered prior to the second parcel P₂ as the scheduled delivery time of the first parcel P₁ is prior to the scheduled delivery time of the second parcel P₂. For example, when the delivery times for the first and second parcels P₁ and P₂ are scheduled, the order management server 116 determines the route and a sequence of parcel deliveries in the route based on the scheduled delivery times.

With reference to FIG. 4B, the first AGV 114a receives the first and second instructions from the order management server 116. Based on the first and second instructions, the first AGV 114a transits from a current location of the first AGV 114a for loading the first and second parcels P₁ and P₂ thereon. When the first AGV 114a detects that the first and second parcels P₁ and P₂ are loaded thereon, the first AGV 114a transits towards the access of the first elevator 128a based on the determined route included in the first instruction. The first AGV 114a then utilizes the first elevator 128a to transit across different floors of the first multistory building 124a and reach the first and second destination locations “D1” and “D2” for delivering the first and second parcels P₁ and P₂ to the first and second users 118 and 402, respectively.

With reference to FIG. 4C, the first AGV 114a is shown to have reached a second floor of the first multistory building 124a by using the first elevator 128a for delivering the second parcel P₂ to the second user 402. After reaching the second floor where the second destination location “D2” is located, the first AGV 114a exits the first elevator 128a and delivers the second parcel P₂ to the second user 402. When the first AGV 114a detects that the second parcel P₂ is unloaded, the first AGV 114a communicates a delivery notification to the order management server 116 indicating that the second parcel P₂ is successfully delivered to the second user 402 at the second destination location “D2”. After delivering the second parcel P₂, the first AGV 114a enters the first elevator 128a again to transit to the first destination location “D1”.

With reference to FIG. 4D, the second parcel P₂ is shown to be delivered to the second user 402. Further, the first AGV 114a is shown to have reached the fourth floor of the first multistory building 124a by using the first elevator 128a for delivering the first parcel P₁ to the first user 118. After delivering the first parcel P₁ to the first user 118 at the first destination location “D1”, the first AGV 114a returns to the first buffer storage 112a.

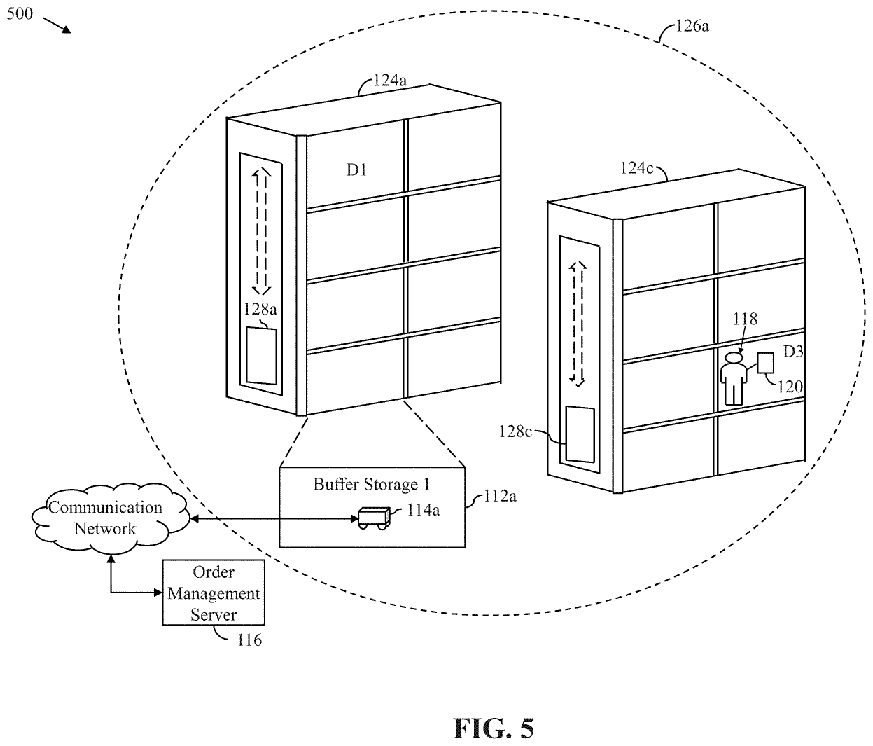

FIG. 5 is a block diagram that illustrates an exemplary scenario 500 for facilitating delivery of parcels to users, in accordance with another exemplary embodiment of the disclosure. The exemplary scenario 500 corresponds to a situation where the first parcel P₁ is temporarily stored in the first buffer storage 112a and the order management server 116 determines that a real-time location “D3” of the first user 118 does not match the first destination location “D1” at the scheduled delivery time of the first parcel P₁.

In such a scenario, the order management server 116 may be configured to recommend the first user 118 to change the destination location for delivering the first parcel P₁ to the third destination location “D3”. The order management server 116 may recommend the first user 118 by communicating a first recommendation message to the first user-device 120. In one example (as shown in FIG. 5), the third destination location “D3” may be within the first service area 126a. If the first user 118 agrees to change the destination location to the third destination location “D3” based on the first recommendation message, the order management server 116 updates the destination location to the third destination location “D3”. The order management server 116 further facilitates the delivery of the first parcel P₁ at the third destination location “D3” by instructing the first AGV 114a as described in the foregoing description of FIG. 3A.

However, if the first user 118 does not agree to change the destination location, the order management server 116 may further recommend the first user 118 to change the scheduled delivery time. The order management server 116 may further communicate a time slot recommendation message to the first user-device 120 based on a past travel history of the first user 118 tracked by the order management server 116. For example, based on the past travel history, the order management server 116 may determine that the first user 118 is at the first destination location “D1” between 6 PM to 9 PM. In such a scenario, the order management server 116 may recommend the first user 118 to change the delivery time and schedule the delivery of the first parcel P₁ between 6 PM to 9 PM. Based on the time slot recommendation message, the first user 118 may update the scheduled delivery time, and the order management server 116 may facilitate the delivery of the first parcel P₁ to the first destination location “D1” at the updated delivery time.

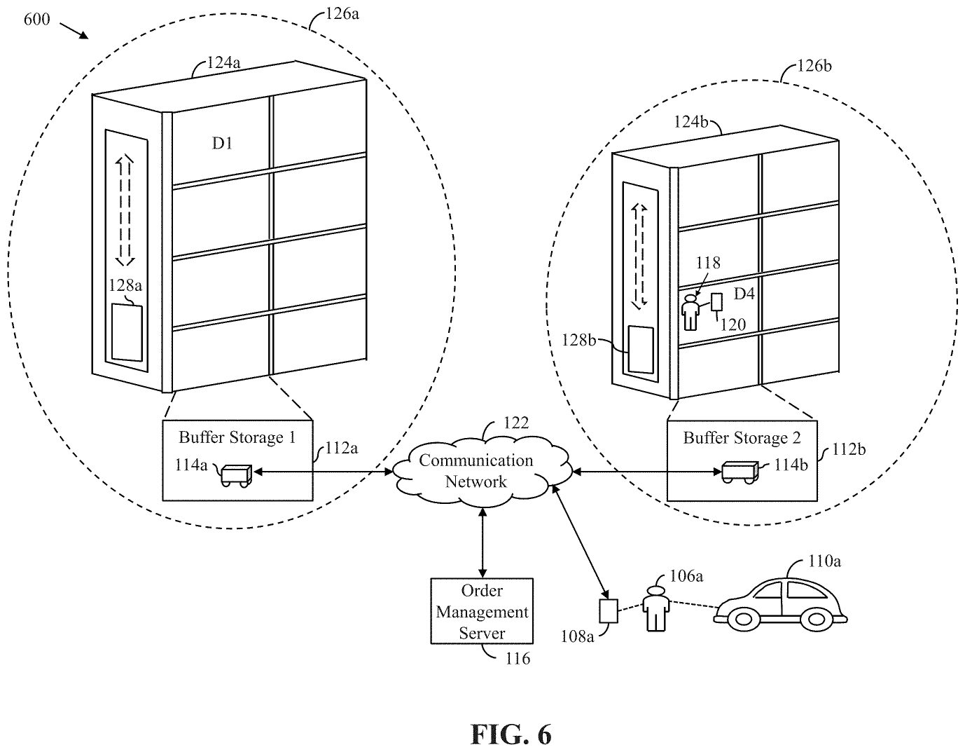

In another example, at the scheduled delivery time, the real-time location of the first user 118 may not match the delivery destination of the first parcel P₁ and may not lie within the first service area 126a. In such a scenario, the order management server 116 recommends the first user 118 to change the destination location for delivering the first parcel P₁, and also facilitates a transfer of the first parcel P₁ from the first buffer storage 112a to a new buffer storage associated with the updated destination location as described in detail in FIG. 6.

FIG. 6 is a block diagram that illustrates an exemplary scenario 600 for facilitating delivery of parcels to users, in accordance with another exemplary embodiment of the disclosure. The exemplary scenario 600 corresponds to a situation where the first user 118 updates the destination location for delivering the first parcel P₁ and the updated destination location (e.g., a fourth destination location “D4”) is not within the first service area 126a of the first buffer storage 112a where the first parcel P₁ is currently stored.

In such a scenario, the order management server 116 is configured to determine a new buffer storage (e.g., the second buffer storage 112b) that is associated with the fourth destination location “D4”. The order management server 116 further communicates a delivery request to a mobile-device (e.g., the first or second mobile-device 108a or 108b) of one of the delivery coordinators 106 for transferring the first parcel P₁ from the first buffer storage 112a to the second buffer storage 112b. After the first parcel P₁ is successfully transferred to the second buffer storage 112b by the first delivery coordinator 106a, the order management server 116 facilitates a delivery of the first parcel P₁ from the second buffer storage 112b to the fourth destination location “D4” in a similar manner as described in the foregoing description of FIGS. 3A-3F.

FIG. 7 is a block diagram that illustrates the order management server 116, in accordance with an exemplary embodiment of the disclosure. The order management server 116 includes a processor 702, a memory 704, and a transceiver 706 that communicate with each other by way of a first communication bus 708. The processor 702 includes a storage manager 710, a request handler 712, a layout manager 714, a route identifier 716, and a location tracker 718 that communicate with each other by way of a second communication bus 720. It will be apparent to a person of ordinary skill in the art that the order management server 116 shown in FIG. 7 is for illustrative purposes and is not limited to any specific combination of hardware circuitry and/or software.

The processor 702 includes suitable logic, instructions, circuitry, interfaces, and/or code, executable by the circuitry, for executing various operations, such as item procurement operations, order fulfillment operations, or the like. Examples of the processor 702 may include, but are not limited to, an application-specific integrated circuit (ASIC) processor, a reduced instruction set computing (RISC) processor, a complex instruction set computing (CISC) processor, a field-programmable gate array (FPGA), and the like.

The memory 704 includes suitable logic, instructions, circuitry, interfaces, and/or code, executable by the circuitry, to store an order list 722, parcel storage data 724, layout information 726, and AGV data 728. Examples of the memory 704 include a random-access memory (RAM), a read-only memory (ROM), a removable storage drive, a hard disk drive (HDD), a flash memory, a solid-state memory, and the like. In one embodiment, the memory 704 may be realized through various database technologies such as, but not limited to, Microsoft® SQL, Oracle®, IBM DB2®, Microsoft Access®, PostgreSQL®, MySQL® and SQLite®. It will be apparent to a person skilled in the art that the scope of the disclosure is not limited to realizing the memory 704 in the order management server 116, as described herein. In other embodiments, the memory 704 may be realized in form of an external database server or a cloud storage working in conjunction with the order management server 116, without departing from the scope of the disclosure.

The order list 722 includes a list of order requests received from various user-devices, such as the first and second user-devices 120 and 404. The order list 722 further includes details of each order request. In one example, the order list 722 may include the details of the first order such as, item information, the first destination location, delivery preferences (e.g., a scheduled time of delivery), the order ID, or the like.

The parcel storage data 724 includes details of all the parcels stored in the storage units 302. For example, the parcel storage data 724 may include details (such as the dimensions, weight, size, or the like) of the first parcel P₁ that is stored in the first storage unit 302a. The parcel storage data 724 is updated whenever a new parcel is received at the buffer storages 112 and stored in the storage units 302. Based on the parcel storage data 724, the order management server 116 is aware of the storage locations of the parcels stored in the storage units 302.

The layout information 726 includes a virtual map of the buffer storages 112, the multistory buildings 124, and the service areas 126. The virtual map may include information pertaining to the layouts of the buffer storages 112, the multistory buildings 124, and the service areas 126. For example, the virtual map may include locations of the elevators 128 and locations of the fiducial markers placed in the buffer storages 112, the multistory buildings 124, and the service areas 126, or the like. The layout information 726 further includes real-time path availability information of various paths in the buffer storages 112, the multistory buildings 124, and the service areas 126.

The AGV data 728 includes details of the AGVs 114. The details of the AGVs 114 may include a size, dimensions, a load carrying capacity, a size carrying capacity, maximum and minimum speeds, and an identifier (such as a numeric or an alpha-numeric code) of each AGV 114. The details of the AGVs 114 may further include real-time location information and an availability status of each AGV 114.

The transceiver 706 transmits and receives data over the communication network 122 using one or more communication network protocols. The transceiver 706 transmits various requests and messages to the SFMSs 104, the mobile-devices 108, the AGVs 114, and the first and second user-devices 118 and 404. The transceiver 706 receives requests and messages from the SFMSs 104, the mobile-devices 108, the AGVs 114, and the first and second user-devices 118 and 404. Examples of the transceiver 706 include, but are not limited to, an antenna, a radio frequency transceiver, a wireless transceiver, a Bluetooth transceiver, an ethernet based transceiver, a universal serial bus (USB) transceiver, or any other device configured to transmit and receive data.

The processor 702 executes the order fulfillment operations by way of the storage manager 710, the request handler 712, the layout manager 714, the route identifier 716, and the location tracker 718. The storage manager 710 manages the order list 722 stored in the memory 704. For example, the storage manager 710 updates the order list 722 when a new order request is received and whenever there is any change in regards to the parcels stored in the buffer storages 112 (e.g., when a parcel is retrieved from a storage unit for fulfillment of the corresponding order).

The request handler 712 processes all order requests received from various user-devices. For example, the request handler 712 identifies items pertaining to each order request and identifies the storage facilities 102 that store the identified items. The request handler 712 may further communicate the order requests to the SFMSs 104 for fulfillment of the orders. The request handler 712 selects suitable delivery coordinators 106 that may cater to the order requests and communicates the delivery requests to the mobile-devices 108 of the selected delivery coordinators 106.

The layout manager 714 manages the layout information 726. For example, if there is any change in the layout of the buffer storages 112 (e.g., a change in the arrangement of the storage units 302), the multistory buildings 124, and the service areas 126, the layout manager 714 updates the layout information 726 based on the change in the layout.

The route identifier 716 is configured to select optimal routes for the AGVs 114 to transit between the buffer storages 112 and the destination locations of the parcels. In one embodiment, if the AGVs 114 encounter real time obstacles (e.g., faulty elevators 128) while delivering the parcels, the route identifier 716 determines alternate routes for the AGVs 114.

The location tracker 718 is configured to receive the location information from the mobile-devices 108, the AGVs 114, and the first user-device 120. Based on the received location information, the location tracker 718 tracks the real-time locations of the delivery coordinators 106, the AGVs 114, and the first user 118.

FIG. 8 is a block diagram that illustrates the first AGV 114a, in accordance with an exemplary embodiment of the disclosure. It will be apparent to a person of ordinary skill in the art that the second AGV 114 may be structurally and functionally similar to the first AGV 114a, without deviating from the scope of the disclosure. The first AGV 114a includes a first body 800, a controller 802, a moving mechanism 804 (such as first through third wheels 804a-804c), and a parcel holder 806.

The controller 802 controls functions of the first AGV 114a. The controller 802 may receive commands and instructions from the order management server 116 by way of a transceiver (not shown) included in the first body 800. The first body 800 may further include a navigation unit 808, a load detector 810, an obstacle detector 812, a fiducial marker reading system (FMRS) 814, and a battery 816.

The moving mechanism 804 enables the first AGV 114a to travel from one location to the other. The parcel holder 806 corresponds to a storage container of the first AGV 114a for loading the parcels that are to be delivered to the users. The parcel holder 806 may be of any shape (such as cube, sphere, cylinder, or the like) that ensures the safety of the parcels during the transit.

The navigation unit 808 may include suitable logic, instructions, circuitry, interfaces, and/or code, executable by the circuitry, for receiving navigation information from the order management server 116. The navigation information may include route details of the determined route that is to be traversed by the first AGV 114a. The first body 800 may further include a motor to control the first moving mechanism 804. For example, the motor may control the first moving mechanism 804a for controlling a speed of the first AGV 114a. The motor may be subject to control by the controller 802 based on the navigation information. An example of the navigation unit 808 may include a GPS. The navigation unit 808 may further determine a real-time location of the first AGV 114a in the first service area 126a. The controller 802 may utilize the navigation unit 808 to navigate the first service area 126a.

The load detector 810 includes suitable logic, instructions, circuitry, interfaces, and/or code, executable by the circuitry, for measuring a weight of the parcels carried by the first AGV 114a. In one embodiment, the load detector 810 may be configured to detect loading and unloading of parcels. For example, when a parcel is loaded on the first AGV 114a, the load detector 810 detects an increase in the measured weight. Increase in the measured weight indicates that the parcel is loaded on the first AGV 114a. When the weight measured by the load detector 810 decreases, the load detector 810 detects that the loaded parcel is unloaded.

The obstacle detector 812 may include suitable logic, instructions, circuitry, interfaces, and/or code, executable by the circuitry, for detecting obstacles in the route being traversed by the first AGV 114a. If the obstacle detector 812 detects an obstacle, the controller 802 may decelerate the first AGV 114a to bring the first AGV 114a to a temporary halt until the obstacle is cleared, thereby avoiding a collision of the first AGV 114a with the obstacle.

The FMRS 814 may include suitable logic, instructions, circuitry, interfaces, and/or code, executable by the circuitry, for scanning and reading the fiducial markers and, consequently, navigating the route allocated to the first AGV 114a. The FMRS 814 may communicate details of a fiducial marker to the controller 802 when the first AGV 114a reaches the fiducial marker. Consequently, the controller 802 may communicate the details of the fiducial marker (i.e., the location information) to the order management server 116 by way of the transceiver. The order management server 116 tracks the movement of the first AGV 114a by way of the details of the fiducial markers communicated by the controller 802 to the order management server 116.

The battery 816 is a rechargeable battery used by the first AGV 114a to power operations executed by the first AGV 114a. The battery 816 may be one of a lead-acid battery, a lithium-ion battery, a lead-acid battery, a nickel-metal hydride battery, or the like.

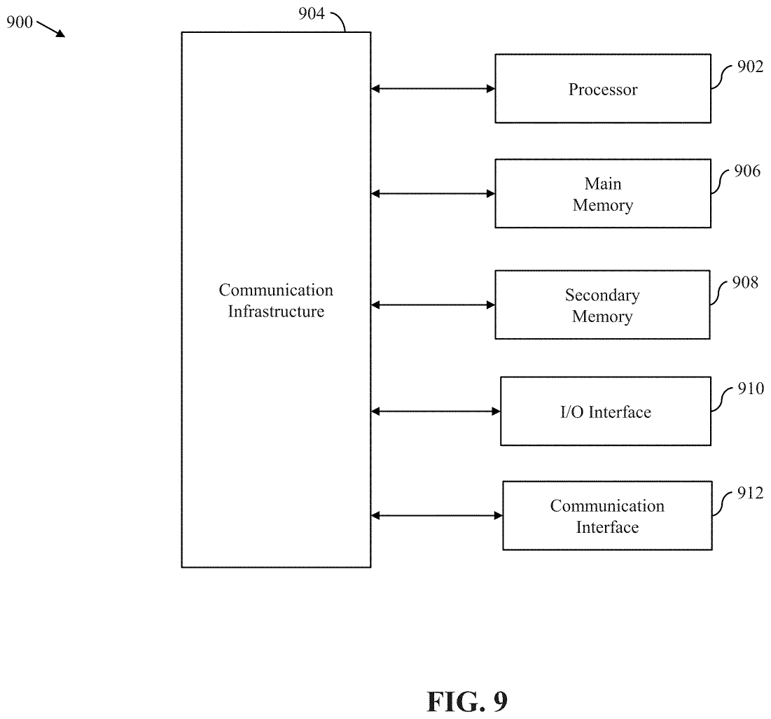

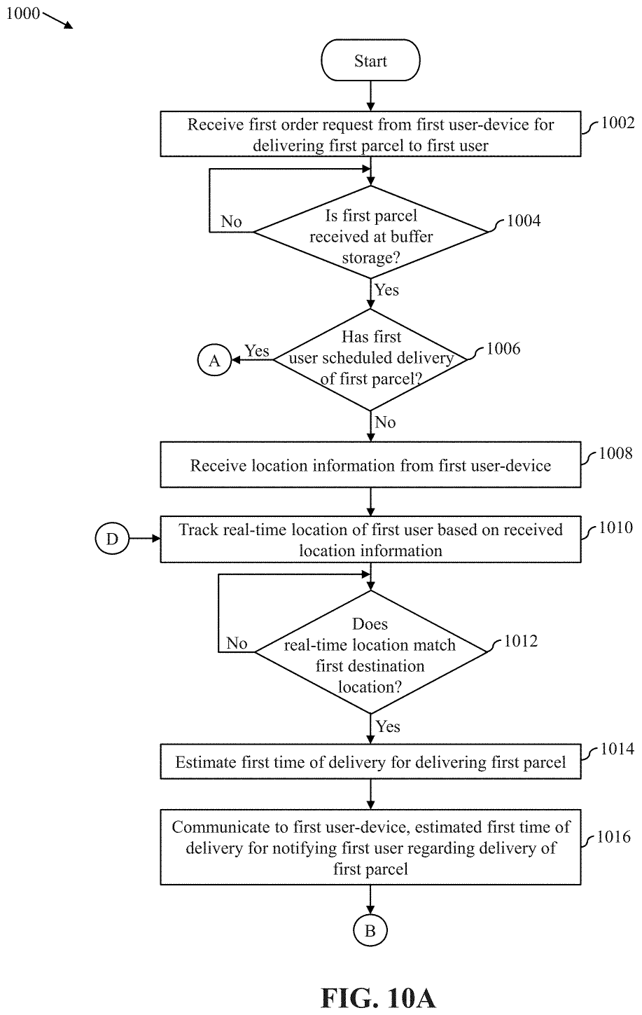

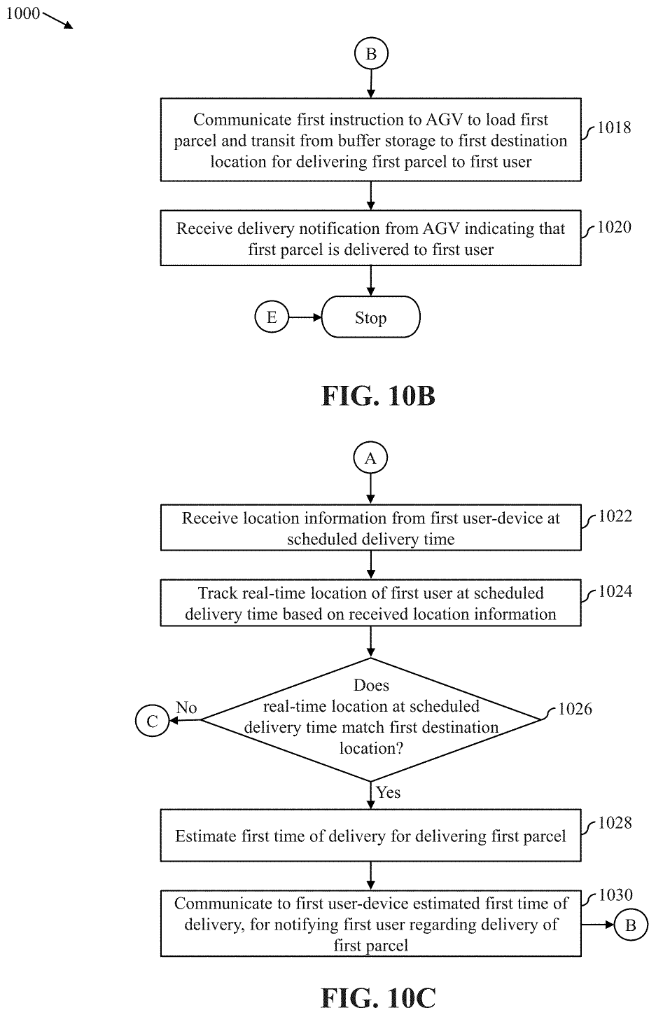

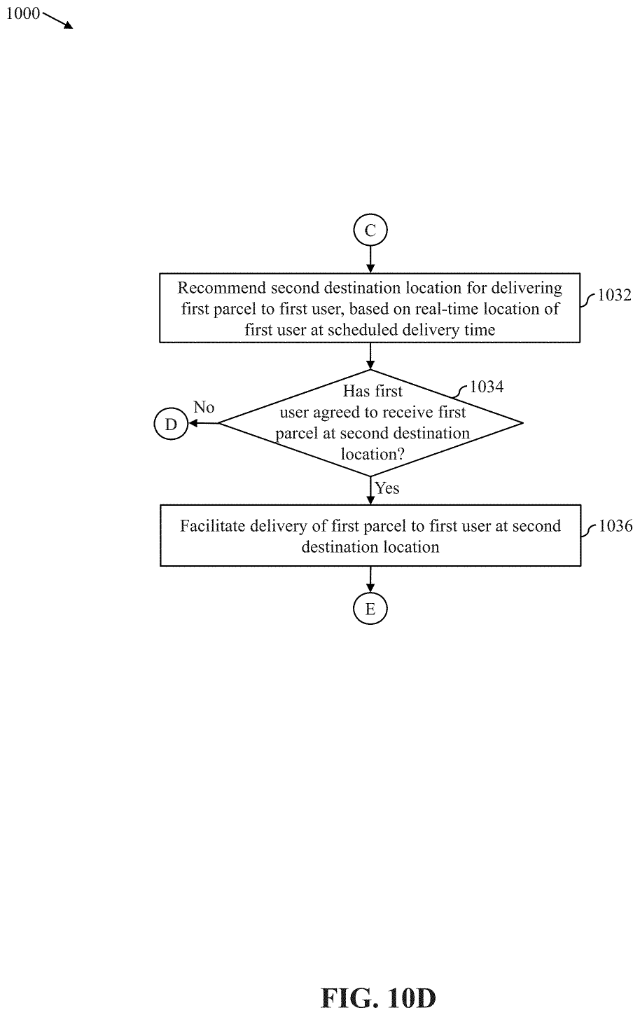

FIG. 9 is a block diagram that illustrates system architecture of a computer system 900, in accordance with an exemplary embodiment of the disclosure. An embodiment of disclosure, or portions thereof, may be implemented as computer readable code on the computer system 900. In one example, the SFMSs 104, the AGVs 114, and the order management server 116 may be implemented in the computer system 900. Hardware, software, or any combination thereof may embody modules and components used to implement methods of FIGS. 10A-10D, 11, and 12. The computer system 900 includes a processor 902 that may be connected to a communication infrastructure 904. The computer system 900 may further include a main memory 906 and a secondary memory 908. The computer system 900 further includes an input/output (I/O) interface 910 and a communication interface 912. The communication interface 912 may allow data transfer between the computer system 900 and various devices that are communicatively coupled to the computer system 900.

FIGS. 10A-10D, collectively represent a flow chart 1000 that illustrates a process (e.g., method) for facilitating delivery of parcels to users, in accordance with an exemplary embodiment of the disclosure. In some embodiments, the process is performed by the order management server 116.

The process may generally start at step 1002, where the order management server 116 receives the first order request from the first user-device 120 for delivering the first parcel P₁ to the first user 118 at the first destination location “D1”. The process proceeds to step 1004, where the order management server 116 determines whether the first parcel P₁ is received at the first buffer storage 112a. If at step 1004, it is determined that the first parcel P₁ is not received at the first buffer storage 112a, the process remains at step 1004. If at step 1004, it is determined that the first parcel P₁ is received at the first buffer storage 112a, the process proceeds to step 1006. At step 1006, the order management server 116 determines whether the first user 118 has scheduled the delivery of the first parcel P₁. If at step 1006 it is determined that the first user 118 has scheduled the delivery time of the first parcel P₁, the process proceeds to process A as illustrated in FIG. 10C. If at step 1006 it is determined that the first user 118 has not scheduled the delivery time of the first parcel P₁, the process proceeds to step 1008. At step 1008, the order management server 116 receives location information from the first user-device 120 of the first user 118. The process proceeds to step 1010, where the order management server 116 tracks the real-time location of the first user 118 based on the received location information. The process proceeds to step 1012, where the order management server 116 determines whether the real-time location of the first user 118 matches the first destination location “D1” specified by the first user 118. If at step 1012, it is determined that the real-time location of the first user 118 does not match the first destination location “D1”, the process remains at step 1012. If at step 1012, it is determined that the real-time location of the first user 118 matches the first destination location “D1”, the process proceeds to step 1014. At step 1014, the order management server 116 estimates the first time of delivery for delivering the first parcel P₁ to the first user 118 at the first destination location “D1”. The process proceeds to step 1016, where the order management server 116 communicates the estimated first time of delivery to the first user-device 120. The process proceeds to process B as illustrated in FIG. 10B.

With reference to FIG. 10B, the process B proceeds to step 1018, where the order management server 116 communicates the first instruction to the first AGV 114a to load the first parcel P₁ and transit from the first buffer storage 112a to the first destination location “D1” for delivering the first parcel P₁ to the first user 118. The process proceeds to step 1020, where the order management server 116 receives the delivery notification from the first AGV 114a indicating that the first parcel P₁ is delivered to the first user 118. After step 1020 is performed, the process B stops.

With reference to FIG. 10C, the process A proceeds to step 1022, where the order management server 116 receives the location information from the first user-device 120 at the scheduled delivery time. The process proceeds to step 1024, where the order management server 116 tracks the real-time location of the first user 118 at the scheduled delivery time based on the received location information. The process proceeds to step 1026, where the order management server 116 determines whether the real-time location of the first user 118 matches the destination location of the first parcel P₁. If at step 1026, it is determined that the real-time location of the first user 118 does not match the destination location of the first parcel P₁, the process proceeds to process C as illustrated in FIG. 10D. If at step 1026, it is determined that the real-time location of the first user 118 matches the destination location of the first parcel P₁, the process proceeds to step 1028. At step 1028, the order management server 116 estimates the first time of delivery for delivering the first parcel P₁ to the first user 118. The process proceeds to step 1030, where the order management server 116 communicates the estimated first time of delivery to the first user-device 120 for notifying the first user 118 regarding the delivery of the first parcel P₁. After step 1030 is performed, the process proceeds to process B as illustrated in FIG. 10B.

With reference to FIG. 10D, the process C proceeds to step 1032, where the order management server 116 recommends the second destination location to the first user 118 for delivering the first parcel P₁ based on the real-time location of the first user 118 at the scheduled delivery time. The process proceeds to step 1034, where the order management server 116 determines whether the first user 118 has agreed to receive the first parcel P₁ at the second destination location. If at step 1034, it is determined that the first user 118 has not agreed to receive the first parcel P₁ at the second destination location, the process proceeds to process D as illustrated in FIG. 10A and then proceeds to step 1010 as illustrated in FIG. 10A. If at step 1034, it is determined that the first user 118 has agreed to receive the first parcel P₁ at the second destination location, the process proceeds to step 1036. At step 1036, the order management server 116 facilitates the delivery of first parcel P₁ to the first user 118 at the second destination location “D2”. The process proceeds to process E and the process illustrated in FIGS. 10A-10D stops.

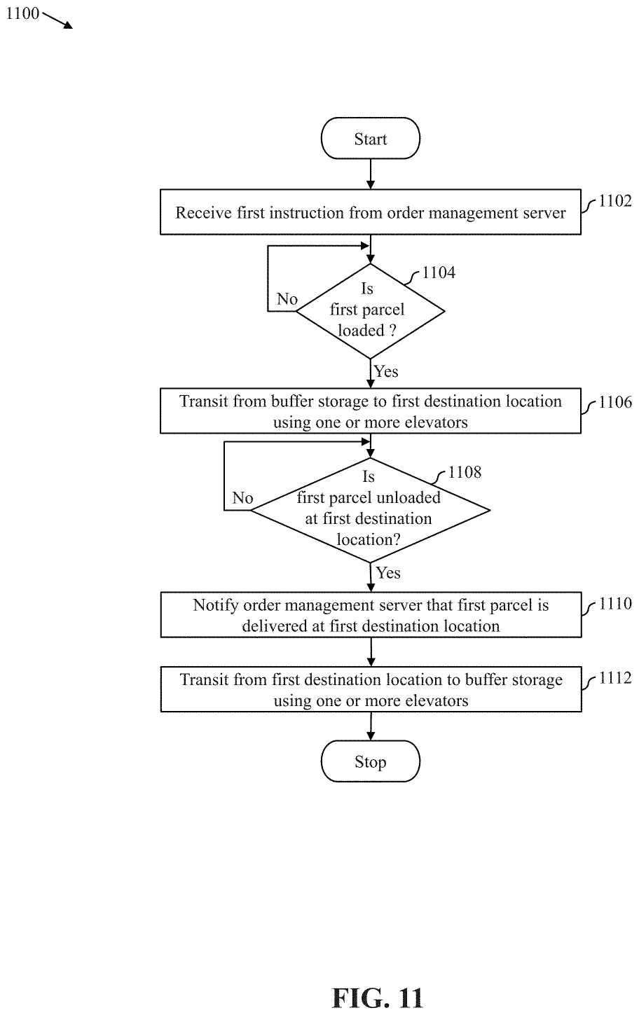

FIG. 11 is a flow chart 1100 that illustrates a process (e.g., a method) for facilitating delivery of parcels, in accordance with an exemplary embodiment of the disclosure. In some embodiments, the process is performed by the first AGV 114a. It will be apparent to a person of ordinary skill in the art that the process may also be performed by the second AGV 114b, without deviating from the scope of the disclosure.

The process may generally start at step 1102, where the first AGV 114a receives the first instruction from the order management server 116, instructing the first AGV 114a to deliver the first parcel P₁ to the first user 118 at the first destination location “D1”. The process proceeds to step 1104, where the first AGV 114a determines whether the first parcel P₁ is loaded thereon based on the first instruction. If at step 1104, it is determined that the first parcel P₁ is not loaded on the first AGV 114a, the process remains at step 1104 until the first parcel P₁ is loaded. If at step 1104, it is determined that the first parcel P₁ is loaded on the first AGV 114a, the process proceeds to step 1106. At step 1106, the first AGV 114a transits from the first buffer storage 112a to the first destination location “D1” using the first elevator 128a of the first multistory building 124a. The process proceeds to step 1108, where the first AGV 114a determines whether the first parcel P₁ is unloaded at the first destination location “D1”. If at step 1108, it is determined that the first parcel P₁ is not unloaded at the first destination location “D1”, the process remains at step 1108. If at step 1108, it is determined that the first parcel P₁ is unloaded at the first destination location “D1”, the process proceeds to step 1110. At step 1110, the first AGV 114a communicates a delivery notification to the order management server 116 indicating that the first parcel P₁ is delivered at the first destination location “D1”. The process proceeds to step 1112, where the first AGV 114a transits from the first destination location “D1” to the first buffer storage 112a using the first elevator 128a and the process stops illustrated in FIG. 11 stops.

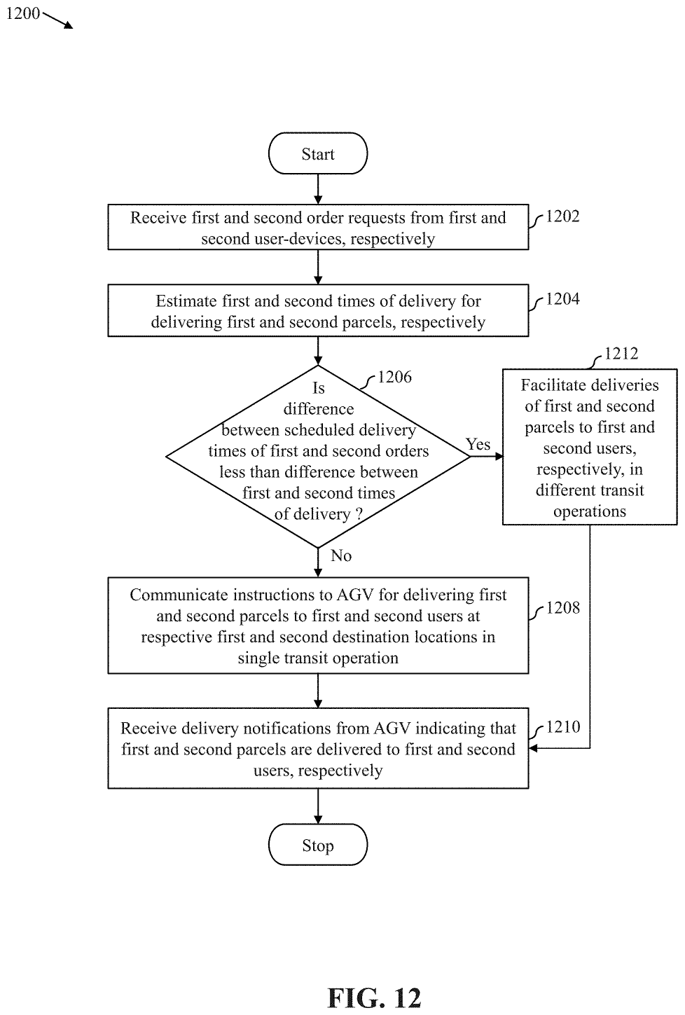

FIG. 12 is a flow chart 1200 that illustrates a process (e.g., a method) for facilitating delivery of multiple parcels in a single transit operation, in accordance with an exemplary embodiment of the disclosure. In some embodiments, the process is performed by the order management server 116.

The process may generally start at step 1202, where the order management server 116 receives the first and second order requests from the first and second user-devices 120 and 404, respectively. The process proceeds to step 1204, where the order management server 116 estimates the first and second times of delivery for delivering the first and second parcels P₁ and P₂ respectively. The process proceeds to step 1206, where the order management server 116 determines whether the difference between the scheduled delivery times of the first and second orders is less than a difference between the estimated first and second times of delivery. If at step 1206, it is determined that the difference between the scheduled delivery times of the first and second orders is greater than the difference between the estimated first and second times of delivery, the process proceeds to step 1208. At step 1208, the order management server 116 communicates the instructions to the first AGV 114a for delivering the first and second parcels P₁ and P₂ at the respective first and second destination locations “D1” and “D2” in a single transit operation. The process proceeds to step 1210, where the order management server 116 receives delivery notifications indicating that the first and second parcels P₁ and P₂ are delivered to the first and second users 118 and 402, respectively. If at step 1206, it is determined that the difference between the scheduled delivery times of the first and second orders is less than the difference between the estimated first and second times of delivery, the process proceeds to step 1212. At step 1212, the order management server 116 facilitates deliveries of the first and second parcels P₁ and P₂ to the first and the second users 118 and 402, respectively, in different transit operations of the first AGV 114a. The process returns from step 1212 to step 1210. After step 1210 is performed, the process illustrated in FIG. 12 stops.

The inclusion of the buffer storages 112 in the multistory buildings 124 enables fast and efficient last mile delivery of parcels. By utilizing the buffer storages 112 and the AGVs 114 stationed at the buffer storages 112, the order management server 116 automates the last mile delivery of the parcels. Technological improvements in the order management server 116 enables the order management server 116 to track the real-time locations of the users who have placed the orders. The order management server 116 utilizes the tracked real-time locations of the users to plan and execute the last mile delivery of parcels. For example, as described in FIGS. 3A-3F, the order management server 116 instructs the first AGV 114a to deliver the first parcel P₁ at the first destination location “D1” when the first user 118 is present at the first destination location “D1”. Thus, minimizing the likelihood of a scenario when the delivery attempt fails due to the absence of the first user 118 to receive the first parcel P₁. The order management server 116 is further capable of clubbing the last mile delivery of multiple parcels without causing any delay in the scheduled delivery times of the parcels. For example, the order management server 116 may club the last mile delivery of parcels when the difference between the scheduled delivery times of the parcels is greater than or equal to the difference between the estimated times of delivery for the parcels. Since the order management server 116 notifies a user regarding the exact time of delivery, the inconvenience caused to the user is reduced. In addition, as the last mile delivery is performed by the AGVs 114 instead of the delivery coordinators 106, the inconvenience caused to the delivery coordinators 106 due to failed delivery attempts is reduced.

A person of ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present disclosure provide, among other features, systems and methods for facilitating delivery of parcels to users. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

What is claimed is:

1. A system for facilitating delivery of a first parcel to a first user, the system comprising:
one or more automated guided vehicles (AGVs) stationed at a buffer storage in a multistory building, wherein the buffer storage stores the first parcel for delivering to the first user at a first destination location that is within a service area associated with the buffer storage; and
an order management server communicatively coupled to the one or more AGVs, the order management server configured to:
receive location information from a user-device of the first user,
track a location of the first user based on the location information,
communicate a first instruction to a first AGV of the one or more AGVs to load the first parcel thereon and transit from the buffer storage to the first destination location for delivering the loaded first parcel to the first user, based on a match between the tracked location and the first destination location.

2. The system of claim 1, wherein the order management server is further configured to determine a route to be followed by the first AGV for transiting from the buffer storage to the first destination location, wherein the first instruction includes information of the determined route, and wherein the first AGV follows the determined route to reach the first destination location from the buffer storage to deliver the first parcel to the first user.

3. The system of claim 1, wherein the order management server further communicates the first instruction to the first AGV based on one or more delivery preferences of the first user and one or more parameters associated with the first parcel.

4. The system of claim 3, wherein the one or more delivery preferences include at least one of the first destination location and a scheduled delivery time specified by the first user for delivering the first parcel, and wherein the one or more parameters associated with the first parcel include a size, a shape, a weight, a material, and one or more dimensions of the first parcel.

5. The system of claim 4, wherein the order management server is further configured to recommend the first user to change the first destination location to a different destination location when the first destination location is different from the tracked location at the scheduled delivery time specified by the first user.

6. The system of claim 3, wherein the order management server is further configured to estimate a first time of delivery for delivering the first parcel based on the match between the tracked location and the first destination location, and the one or more delivery preferences of the first user.

7. The system of claim 6, wherein the order management server is further configured to communicate to the user-device the estimated first time of delivery for notifying the first user regarding the delivery of the first parcel.

8. The system of claim 6, wherein the order management server is further configured to:
determine a difference between the first time of delivery and a second time of delivery, wherein the second time of delivery is associated with a second parcel that is stored in the buffer storage and is to be delivered to a second user at a second destination location that is within the service area associated with the buffer storage, and
communicate a second instruction to the first AGV to further load the second parcel thereon for delivering the second parcel to the second user at the second destination location based on the determined difference, wherein the first AGV delivers the first and second parcels to the first and second users at the respective first and second destination locations in a single transit operation, based on the first and second instructions.

9. The system of claim 1, wherein the first AGV is further configured to:
receive the first instruction from the order management server,
detect whether the first parcel is loaded thereon based on the first instruction, and
transit from the buffer storage to the first destination location based on the detection that the first parcel is loaded, for delivering the first parcel to the first user.

10. The system of claim 9, wherein the first AGV is further configured to:
detect whether the first parcel is unloaded at the first destination location,
communicate a delivery notification to the order management server based on the detection that the first parcel is unloaded, wherein the delivery notification indicates that the first parcel is delivered to the first user at the first destination location, and
transit from the first destination location to the buffer storage based on the detection that the first parcel is unloaded.

11. The system of claim 1, wherein the first AGV is further configured to use one or more elevators associated with the multistory building for transiting from the buffer storage to the first destination location.

12. A method for facilitating delivery of a first parcel to a first user, the method comprising:
determining, by an order management server, whether the first parcel is received at a buffer storage in a multistory building based on an order placed by the first user for the first parcel, wherein the buffer storage stores the first parcel for delivering to the first user at a first destination location, and wherein the buffer storage caters to the first destination location;
receiving, by the order management server, location information from a user-device of the first user based on the determination that the first parcel is received at the buffer storage;
tracking, by the order management server, a location of the first user based on the received location information; and
communicating, by the order management server, a first instruction to an automated guided vehicle (AGV) stationed at the buffer storage to load the first parcel thereon and transit from the buffer storage to the first destination location for delivering the loaded first parcel to the first user, wherein the first instruction is communicated based on a match between the tracked location and the first destination location.

13. The method of claim 12, further comprising:
receiving, by the order management server, information of the order placed by the first user; and
facilitating, by the order management server, based on the information of the order, a delivery of the first parcel from a storage facility to the first destination location by utilizing the buffer storage and the AGV stationed at the buffer storage.

14. The method of claim 12, further comprising communicating, by the order management server, the first instruction to the AGV based on one or more delivery preferences of the first user and one or more parameters associated with the first parcel.

15. The method of claim 14, wherein the one or more delivery preferences include at least one of the first destination location and a scheduled delivery time specified by the first user for delivering the first parcel, and wherein the one or more parameters associated with the first parcel include at least one of a size, a shape, a weight, a material, or one or more dimensions of the first parcel.

16. The method of claim 15, further comprising recommending, by the order management server, the first user to change the first destination location to a different destination location, when the first destination location is different from the tracked location at the scheduled delivery time specified by the first user.

17. The method of claim 14, further comprising estimating, by the order management server, a first time of delivery for delivering the first parcel based on the match between the tracked location and the first destination location, and the one or more delivery preferences of the first user.

18. The method of claim 17, further comprising communicating, by the order management server to the user-device, the estimated first time of delivery for notifying the first user regarding the delivery of the first parcel.

19. The method of claim 17, further comprising:
determining, by the order management server, a difference between the first time of delivery and a second time of delivery, wherein the second time of delivery is associated with a second parcel that is stored in the buffer storage and is to be delivered to a second user at a second destination location that is serviced by the buffer storage; and
communicating, by the order management server, a second instruction to the AGV to further load the second parcel thereon for delivering the second parcel to the second user at the second destination location based on the determined difference, wherein the AGV delivers the first and second parcels to the first and second users at the respective first and second destination locations in a single transit operation based on the first and second instructions.

20. The method of claim 12, further comprising:
determining, by the order management server, a route to be followed by the AGV for transiting from the buffer storage to the first destination location, wherein the first instruction includes information of the determined route, and wherein the AGV follows the determined route to reach the first destination location from the buffer storage to deliver the first parcel to the first user; and
receiving, by the order management server from the AGV, a delivery notification indicating that the first parcel is delivered to the first user at the first destination location.
